(19) United States
(12) Patent Application Publication
(10) Pub. No.: US 2024/0217136 A1
(43) Pub. Date: Jul. 4, 2024

(54) A SYSTEM OF OPERATING MEMBERS FOR 3D-PRINTING OF ELEMENTS OF BUILDINGS AND STRUCTURES AND FOR SMOOTHING AND TREATING THEIR SURFACES WITH LIQUIDS (VARIANTS)

(71) Applicant: Kostiantyn Kostiantynovych BARASHKIN, Kyiv (UA)

(72) Inventor: Kostiantyn Kostiantynovych BARASHKIN, Kyiv (UA)

(21) Appl. No.: 18/563,459

(22) PCT Filed: Oct. 4, 2021
(86) PCT No.: PCT/UA2021/000085

§ 371 Date: Nov. 22, 2023

(30) Foreign Application Priority Data
Jul. 28, 2021 (UA) A 2021 04388

(51) Int. Cl. B28B 1/00; B33Y 30/00; B33Y 40/20

(52) U.S. Cl. CPC B28B 1/001; B33Y 30/00; B33Y 40/20

(57) ABSTRACT

The invention relates to additive technologies in a building industry, and it may be used to build structures, houses, and other objects. The problem to be solved by the present invention is the creation of operating members system for 3D-printing of elements of buildings and structures and for smoothing and treating their surfaces with liquids, wherein the system allows construction of building elements by 3D-printing with simultaneous alignment and/or treatment of surfaces of building elements in a single operating cycle. The system achieves an automatic performing of “an additional treatment” of the printed elements of buildings or constructions without involvement of additional labor or mechanical resources. The solution of the problem is achieved through two variants for the system, which allows to achieve a quick printing of complex protruding and recessed elements of buildings and constructions and to perform the smoothing and the treatment of their surfaces.

### TECHNICAL FIELD OF THE INVENTION

The invention relates to additive technologies in a building industry, and it may be used to build structures, houses, and other objects. The invention is a structure of a system of operating members for 3D-printing of elements of buildings and structures and for smoothing and treating their surfaces with liquids. The term “the system of operating members” means a complex of details and structural elements which are directly intended to perform 3D-printing and which constitute a part of the entire 3D-printing system that comprises other supplementary structural elements and details except for “the system of operating members”.

### PRIOR ART

Additive technologies in a building industry are 3D-printing technologies which help to print (to build) a building object or a part thereof by a successive depositing layers of extruded building materials one on another. A process of conduction of the 3D-printing of a complete volumetric object or its separate structural element by depositing a plurality of layers of the material from a first layer to a last layer is “a single operation cycle of the system” for the 3D-printing.

Various different structures are known which disclose a possibility of a simultaneous 3D-printing with various materials and/or which allow to mount a reinforcement during the 3D-printing, and/or provide building (printing) of objects having smoothed surfaces (preferably, smoothed vertical external surfaces of buildings and structures are meant).

A system for 3D-printing of a tower structure of a wind turbine, the system comprising a multi-head (multi-extruder) device for an additive printing that prints a reinforcement of the tower together with a concrete simultaneously (international publication of the invention application WO2020068793A1, IPC B29C 64/106, B33Y 10/00, E04G 21/04; publ. on 2 Apr. 2020 [1]). Also, this system may comprise a plurality of robotized manipulators which are mounted on a shared base of a central framed structure, and each of them has an extruder to print the reinforcement and an extruder to print the concrete. In this system, polymeric or metal materials are used to install the reinforcement. Said multi-extruder additive printing device is designed with nozzles for a batched supplying the polymeric and/or metal and bonding material. The 3D-printing technology of such system implies a preliminary printing of an inner and an outer walls of the tower structure of the wind turbine from the polymeric material followed by filling a space between these walls with the bonding material. After the concrete is hardened, a polymer form may be removed, e.g., by a biodegradation of the polymeric material in a course of time under influence of environmental conditions. However, such system is not intended to perform a simultaneous 3D-printing and a simultaneous process of smoothing or treating of at least one vertical outer surface of the element to be built during a single operation cycle of this system.

Also, a 3D-printing device is known, the device comprising a gantry-type frame having three extruders movably fixed thereon (Chinese invention patent CN 107756594A, IPC B28B 1/00, B28B 1/52, B29C 64/20, publ. on 6 Mar. 2018 [2]). Three extruders provide printing with various materials, namely, with a fiber composite, a highly polymeric material, and a concrete mixture. A first extruder prints an outer frame of the highly polymeric material. After the outer frame is formed, a second extruder fills a volume of a formed shell with the concrete mixture. During a process of forming a concrete wall between layers of the concrete mixture, a third extruder prints a continuous fiber that acts to reinforce the concrete wall. After the printing is completed, the plastic shell is removed by a hot melting. This device also is not intended to perform a simultaneous 3D-printing and a simultaneous process of smoothing or treating of at least one vertical outer surface of the element to be built during a single operation cycle of this system.

Furthermore, a drawback of the described technical solutions lies in a complexity and a significant duration of conduction of the building processes, firstly, the 3D-printing of the forms or outer walls is conducted, and then the 3D-printing with the concrete mixture is conducted. The printing of the outer frame from the polymeric material followed by the required removal of this outer frame upon completion of the 3D-printing are two operations which are interrelated and mutually exclusive at the same time, and their conductions causes significant unreasonable material and time costs. Furthermore, if authors, by means of printing the outer frame from the highly polymeric material, suggest to print building structures having the smoothed surface, the smoothing of the outer surface of the outer frame from the highly polymeric material will not be clear. Most likely, in order to perform this, it will be necessary to perform a selection of a chemical formulation of the highly polymeric material and conditions of its manufacturing in order to provide the required parameters of a fluidity and a hardening rate of the highly polymeric material used for the printing. Moreover, even if it is possible to print the outer frame having the smoothed inner surface by means of selecting the chemical formulation and a consistency of the highly polymeric material, it remains unclear how the described structures may provide a guaranteed smoothed outer surface of the wall that is printed from the concrete mixture. It is obvious that, to this end, the concrete mixture must be characterized by increased characteristics of the fluidity in order each layer of the concrete mixture could evenly and firmly distribute between the walls of the outer frame. However, in practice, it is very difficult to perform and, after such walls are built (upon completion of the 3D-printing), it is necessary to involve additional labor or mechanical resources for an additional processing thereof, e.g., for their smoothing and straightening. Therefore, additional operations which lead to significant unreasonable material or time costs in a combination with special requirements as to the materials used in the printing represent significant drawbacks of such technical solutions.

A 3D-printer for constructing a reinforced concrete wall is known, the printer is intended to conduct 3D-printing of outer and inner walls from a plastic mortar of an artificial stone material, the outer and the inner walls are reinforced during the construction process, and a space formed between them is filled with a thermal-insulating material. Therewith, the reinforcing is performed in vertical and horizontal planes by means of embedding an alkali-proof fabric web having a cell size of at least 20×20 mm into a newly printed layer of the concrete mixture or into a plurality of newly printed layers of the concrete mixture. The web is fixed in the layer of the concrete mixture by means of metal U-shaped brackets. A dispersion-reinforced fine-grained concrete mixture having a concrete workability mark being P1 is used as the plastic mortar of the artificial stone material, while a thixotropic foamed concrete mixture is used as the thermal-insulating material (RU invention patent No. 2 725 716, IPC E04B 2/84, B33Y 30/00, publ. on 3 Jul. 2020 [3]). A drawback of such 3D-printer lies in a fact that it does not provide a simultaneous smoothing of the surface of the wall being built during the printing process.

A system for performing a method for 3D-printing a concrete wall, wherein a prepared concrete mixture is extruded in a layer by layer fashion and, thus, the concrete wall is constructed; a large amount of water is dispersed under pressure onto a surface of the newly constructed concrete wall from a water pistol, thereby providing a washing of a non-condensed concrete paste from the surface of the printed wall; a membrane coating is applied onto the washed surface of the concrete wall that results in that the treated surface of the wall is straightened and becomes ready for a decorative finishing (Chinese invention patent No. CN107901185A, IPC B28B 1/00, B28B 11/22, B28B 11/24, B33Y 10/00, publ. on 13 Apr. 2018, [4]). A drawback of such system lies in its operation does not immediately result in providing a smoothed (straightened) surface of the wall in a single operation cycle of the system for the 3D-printing in a course of constructing the concrete wall itself. Performing the water dispersing together with the application of the membrane coating represent additional operations which are performed with an involvement of additional devices. Furthermore, it is obvious for a person skilled in the present field of art that the concrete mixtures which are used in the additive technologies are characterized by a quick hardening. Thus, the deposited layers of the material, upon hardening, will maintain their side contours and the constructed wall will be characterized by a rough, wavy surface. Even after the surface of the wall is washed with the large amount of water, the rough, wavy surface of the deposited layers of the material will be preserved, since the pressurized water will “wash out” the non-condensed concrete paste, rather than non-hardened particles of the concrete mixture which form the “roughness and waviness”. The membrane coating also is not able to provide a full straightening of the rough, wavy surface. It should be noted that with consideration of the quick hardening property that is peculiar to the most of building materials which are used for the 3D-printing in the building industry, the most effective way could be to perform a mechanical straightening (smoothing) of a surface of an element being printed immediately after application of the corresponding layer of the 3D-printing material.

A system of operating members for 3D-printing of elements of buildings and structures and for smoothing and treating their surfaces with liquids that is comprised in a 3D-printing device, the system comprising a printing mechanism, a mechanism for smoothing and treating the surfaces with liquids that, in turn, comprises a surface smoothing device and a disperser for liquids, and a connection element for connecting the printing mechanism to a movement manipulator of the system of operating members for 3D-printing, smoothing, and treating the surfaces, wherein the connection element is connected to a link of the movement manipulator, is the closest one to two embodiments of the proposed invention. Therewith, the printing mechanism is configured in a form of at least one extruder (or in a form of several extruders), and one or several such extruders are mounted on the connection element in a movable fashion relative to an object to be printed, as well as one or each of the several extruders are connected to a system for delivering building 3D-printing materials and are configured to apply a plurality of layers of the building material deposited one on another (Chinese invention patent No. CN111827683A, IPC B33Y 30/00, B33Y 40/20, E04G 21/04, publ. on 27 Oct. 2020, [5]). A planishing mechanism is configured as a separate device being a six-axis robot-manipulator with a planishing device and the dispenser for a liquid or liquids mounted thereon. The printing mechanism is configured as a six-axis robot-printer having a manipulator with an extruder for concrete printing and an extruder for metal printing mounted thereon on a shared plate. During conduction of the 3D-printing, only one of the printing devices is active, it is either the extruder for concrete printing or the extruder for metal printing. That is, firstly, the extruder for concrete printing is active, while the extruder for metal printing is in a passive state, and when the required concrete layer is printed, the extruder for concrete printing will be switched to the passive state, and the 3D-printing with the metal is conducted via the extruder for metal printing. Upon conduction of the 3D-printing of the required metal layer, the extruder for metal printing will become inactive again, and the extruder for concrete printing starts to operate. After the required structure is printed by the first six-axis robot-manipulator, the second six-axis robot-printer will be involved to the operation: the planishing mechanism treats the surfaces of the 3D-printed wall and, by means of a mechanical abrasing, removes residual parts of the printed layers of the built object, i.e., it smooths the surfaces of the built element. A drawback of this system lies in that the production of the smoothed surface of the object to be built (e.g., a vertical wall) is not provided directly during printing (constructing) thereof. Thus, the 3D-printing process suffers from significant time costs. Furthermore, the wall is straightened due to treating thereof by planishing with a separate large-dimensioned device. This leads to a significant increase of a cost price for manufacturing of such smooth wall. Therefore, said structure does not enable to perform building of elements of buildings and structures by means of the 3D-printing method with a single layer and a single building material or several layers and several building materials simultaneously with the process of smoothing and/or treating at least one vertical surface of the element being built in a single operation cycle of the system (“the single operation cycle of the system” represents building of a single object, structure). The structure of this system is not intended to achieve an automatic conduction of “an additional treatment” of the printed elements of buildings or structures, and in order to provide “the additional treatment”, the system mandatory requires to perform additional operations and additional mechanical resources, and, as a consequence, the structure and the operation of this system does not allow to achieve a reduction of time, financial, and labor costs, and, at the same time, to increase a quality of the printed elements of buildings and structures. Furthermore, such system of operating members of this 3D-printing device, at the same time, does not enable to print complex protruding and recessed elements of buildings and structures quickly (simultaneously with operations of the main 3D-printing, smoothing, and treating the surfaces of the elements being built with liquids).

Therefore, each of the technical solutions for constructing building structures proposed in the prior art has its own advantages and drawbacks. However, none of the revealed analogues proposes a complex technical solution that could provide a production of printed objects having smoothed surfaces as a result of a single operation cycle of the 3D-printing system and does not enable, at the same time with the mentioned capabilities, to print complex protruding and recessed elements of buildings and structures quickly.

A technical task of the first and the second embodiments of the invention lies in creation of a system of operating members for 3D-printing of elements of buildings and structures and for simultaneous smoothing and treating their surfaces with liquids, wherein a structure of the system could enable to achieve the following technical effects: performing building of elements of buildings and structures by the 3D-printing method with a simultaneous performing of the process of smoothing and/or treating the surfaces of the elements being built in a single operation cycle of the system; that is, the structure of the system is intended to achieve an automatic performing of “an additional treatment” of the printed elements of buildings or structures, at the same time without involvement (after the 3D-printing and the additional treatment are completed) of additional labor or mechanical resources and, as a consequence, the technical effect of the operation of the system structures also lies in a reduction of time, financial, and labor costs and a simultaneous increase of a quality of the printed elements of buildings and structures. At the same time with the mentioned information, the technical effect of operation of the structure of both embodiments of the system also lies in an achievement of a quick printing of complex protruding and recessed elements of buildings and structures and performing of smoothing and treatment of their surfaces.

An additional technical effect of both embodiments of the invention lies in performing of building of elements of buildings and structures by the 3D-printing method with several layers and several building materials at the same time with a simultaneous process of smoothing and/or treating the surfaces of the elements being built.

### SUMMARY OF THE INVENTION

According to the first embodiment of the invention, the posed task is solved by the fact that the system of operating members for 3D-printing of elements of buildings and structures and for smoothing and treating their surfaces with liquids comprises a printing mechanism 1, a mechanism 2 for smoothing and treating surfaces with liquids that comprises a surface smoothing device 8 and a disperser 9 for liquids, and a connection element 4 for connecting the printing mechanism 1 to a movement manipulator 5 of the system of operating members for 3D-printing, smoothing and treating the surfaces, and the connection element 4 is connected to a link 27 of the movement manipulator 5. Therewith, the printing mechanism 1 is made in a form of at least one extruder 3, and one or several such extruders 3 is/are mounted on the connection element 4 in a movable fashion relative to an object 41 to be printed. And one or each of the several extruders 3 is connected to a system 42 for delivering building 3D-printing materials and configured to apply a plurality of layers L of the building material deposited one on another. In the first embodiment of the invention, a novel feature lies in that the connection element 4 is made in a form of a multi-component platform 28 that comprises a guiding element 39 for the extruder 3 or for the several extruders 3, and the multi-component platform 28, in its upper part 29, is connected to the link 27 of the movement manipulator 5 such that the multi-component platform 28 is capable of rotating in a horizontal plane around its own axis Z2. Therewith, the printing mechanism 1 in the form of one or several extruders 3 and the mechanism 2 for smoothing and treating surfaces with liquids are mounted on the multi-component platform 28 such that they are capable of moving together with the multi-component platform 28 relative to the object 41 to be printed. Therewith, the extruder 3 or each of the extruders 3 comprises a motor 35 for an independent horizontal movement of each of the extruders 3 along the guiding element 39 along a horizontal axis X of the multi-component platform 28, as well as the extruder 3 or each of the extruders 3 comprises a motor 36 for an inclination relative to its own vertical axis Z₁ at an angle α of between 0° and 90°, and the extruder 3 or each of the extruders 3 with the motors 35, 36 is mounted in the multi-component platform 28 such that it is capable of moving horizontally towards different directions along the multi-component platform 28 due to the guiding element 39, as well as such that it is capable of inclining each of the extruders 3 towards different directions relative to its own vertical axis Z₁ at an angle α of between 0° and 90°. Furthermore, the mechanism 2 for smoothing and treating surfaces with liquids further comprises a side extruder 10. Therewith, the surface straightening device 8 is made in a form of a smoothing plate 11. And all the elements of the mechanism 2 for smoothing and treating surfaces with liquids: the side extruder 10, the smoothing plate 11, and the liquid dispenser 9 are mounted and fixed to the multi-component platform 28 by means of a movable manipulator 34 of the smoothing mechanism that is freely movable such that a longitudinal axis P of the side extruder 10 is arranged at an angle β of between 0° and 180° relative to a surface of the object 41 to be printed and this angle β is changeable in a course of operation of the system of the operating members. Therewith, the side extruder 10 is connected to the system 42 for delivering building 3D-printing materials and is configured to apply additional layers [symbol] of the 3D-printing material onto surfaces of at least two layers L previously printed by the extruder 3 or several extruders 3. Furthermore, the smoothing plate 11 is arranged such that it is capable of smoothing the additional layers [symbol] of the 3D-printing material in a course of the movement and printing of the side extruder 10.

According to the second embodiment of the invention, the posed task is solved by the fact that the system of operating members for 3D-printing of elements of buildings and structures and for smoothing and treating their surfaces with liquids comprises a printing mechanism 1, a mechanism 2 for smoothing and treating surfaces with liquids that comprises a surface smoothing device 8 and a disperser 9 for liquids, and a connection element 4 for connecting the printing mechanism 1 to a movement manipulator 5 of the system of operating members for 3D-printing, smoothing and treating the surfaces, and the connection element 4 is connected to a link 27 of the movement manipulator 5. Therewith, the printing mechanism 1 is made in a form of at least one extruder 3, and one or several such extruders 3 is/are mounted on the connection element 4 in a movable fashion relative to an object 41 to be printed. And one or each of the several extruders 3 is connected to a system 42 for delivering building 3D-printing materials and configured to apply a plurality of layers L of the building material deposited one on another. In the second embodiment of the invention, a novel feature lies in that the connection element 4 is made in a form of a multi-component platform 28 that comprises a guiding element 39 for the extruder 3 or for the several extruders 3, and the multi-component platform 28, in its upper part 29, is connected to the link 27 of the movement manipulator 5 such that the multi-component platform 28 is capable of rotating in a horizontal plane around its own axis Z2. Therewith, the printing mechanism 1 in the form of one or several extruders 3 and the mechanism 2 for smoothing and treating surfaces with liquids are mounted on the multi-component platform 28 such that they are capable of moving together with the multi-component platform 28 relative to the object 41 to be printed. Therewith, the extruder 3 or each of the extruders 3 comprises a motor 35 for an independent horizontal movement of each of the extruders 3 along the guiding element 39 along a horizontal axis X of the multi-component platform 28, as well as the extruder 3 or each of the extruders 3 comprises a motor 36 for an inclination relative to its own vertical axis Z₁ at an angle α of between 0° and 90°, and the extruder 3 or each of the extruders 3 with the motors 35, 36 is mounted in the multi-component platform 28 such that it is capable of moving horizontally towards different directions along the multi-component platform 28 due to the guiding element 39, as well as such that it is capable of inclining each of the extruders 3 towards different directions relative to its own vertical axis Z₁ at an angle α of between 0° and 90°. Furthermore, the mechanism 2 for smoothing and treating surfaces with liquids is made in a form of a polishing element 12 with a motor 37. All the elements of the mechanism 2 for smoothing and treating surfaces with liquids: the polishing element 12 and the liquid dispenser 9 are mounted and fixed to the multi-component platform 28 by means of a movable manipulator 34 of the smoothing mechanism that is freely movable in different planes such that the polishing element 12 and its working surface 38 are arranged such that an inclination angle γ of the polishing element 12 and its working surface 38 is changeable relative to a surface of the object 41 to be printed during operation of the system of the operating members.

For some specific conditions and cases of use of the inventive structure, the proposed system of operating members is characterized by the following features, which develop, specify the set of features of independent claims of the set of claims for the invention.

The printing mechanism 1 comprises from two to six extruders 3 with from two to six pipelines 24 respectively connected thereto, and the extruders 3 are mounted on the multi-component platform 28 such that they are capable of applying the plurality of the layers L of one building material deposited one on another or several different building 3D-printing materials simultaneously.

The multi-component platform 28 is made in a form of a horizontally arranged U-shaped profile, wherein an upper part 29 of the multi-component platform 28 is closed, and a lower part 30 of the multi-component platform 28 is opened, wherein planes of the U-shaped profile form an inner cavity 33 of the multi-component platform 28 with the guiding element in a form of a horizontal guiding bar 39 mounted therein for one horizontal movement motor 35 of one extruder 3 or for the horizontal movement motors 35 of the extruders 3.

The multi-component platform 28 is made in a form of a horizontally arranged II-shaped profile, wherein an upper part 29 and a lower part 30 of the multi-component platform 28 are opened, and planes of the II-shaped profile form an inner cavity 33 of the multi-component platform 28 with the guiding element in a form of a horizontal guiding bar 39 mounted therein for one horizontal movement motor 35 of one extruder 3 or for the horizontal movement motors 35 of the extruders 3.

The mechanism 2 for smoothing and treating surfaces with liquids further comprises one or several additional liquid dispensers 40, each being configured to dispense identical or different liquids, and each being fixed to the multi-component platform 28 by means of the movable manipulator 34 of the smoothing mechanism that is freely movable in different planes.

The system of operating members for 3D-printing of elements of buildings and structures and for smoothing and treating their surfaces with liquids further comprises a device 13 for reinforcing the object 41 to be printed.

The reinforcing device 13 is made in a form of a hollow housing 15 having a tapered lower part and formed by walls 19, 20, 21, 22, wherein the wall 19 is made straight, while the wall 20 is formed by parts A, B, C, wherein the parts A and C are arranged vertically and connected between each other by the part B that is arranged in an inclined fashion at an angle relative to the walls A and C, while the parts A and B are arranged at an angle of 90°-170° to each other, wherein a movable pusher 16, a tray 17 with brackets 14, and a separator 18 are mounted within the hollow housing 15, and the movable pusher 16 is vertically movable along the wall 19, furthermore, the tray 17 is mounted along the part A of the wall 20 and abuts against the separator 18.

An electric heating element 32 is mounted at an outlet nozzle 31 of one extruder 3 or at each of outlet nozzles 31 of each of the several extruders 3, the electric heating element has the same shape as the shape of the inner walls of the outlet nozzle 31 of the corresponding extruder 3.

### BRIEF DESCRIPTION OF DRAWINGS

Brief description of block diagrams of the proposed invention.

Practical implementation and industrial applicability of the embodiments of the system of operating members for 3D-printing of elements of buildings and structures and for smoothing and treating their surfaces with liquids will be explained by schematic drawings of the structures, in which:

FIG. 1—the system of operating members for 3D-printing having two extruders 3 and the side extruder 10 (the first embodiment);

FIG. 2—the system of operating members for 3D-printing having two extruders 3 and the polishing element 12 (the second embodiment);

FIG. 3—the system of operating members for 3D-printing having one extruder 3 and the side extruder 10 (the first embodiment);

FIG. 4—the system of operating members for 3D-printing—a top view of the multi-component platform 28;

FIG. 5—the system of operating members comprised in the entire 3D-printing system;

FIG. 6—the system of operating members for 3D-printing having two extruders 3 and the polishing element 12 (the second embodiment, rear view);

FIG. 7—the reinforcing device 13 without the front wall 19;

FIG. 8—the reinforcing device 13 without one of the side walls 21;

FIG. 9—the system of operating members for 3D-printing having two extruders 3, with the polishing element 12 and the reinforcing device 13 (the second embodiment);

FIG. 10—the system of operating members for 3D-printing having the multi-component platform 28 in the form of the horizontally arranged U-shaped profile;

FIG. 11—the reinforcing device 13 comprised in the system of operating members for 3D-printing having the multi-component platform 28 in the form of the horizontally arranged U-shaped profile (the second embodiment);

Elements of the structure of both embodiments of the invention are designated with the following numeric positions:
1—a printing mechanism;
2—a mechanism for smoothing and treating surfaces with liquids;
3—extruders;
4—a connection element for connecting the printing mechanism 1 with a movement manipulator 5;
5—the movement manipulator;
6, 7—side walls of a multi-component platform 28;
8—a surface smoothing device;
9—a disperser for liquids;
10—a side extruder;
11—a smoothing plate;
12—a polishing element;
13—a reinforcing device;
14—brackets (metal or other);
15—a hollow housing of the reinforcing device 13;
16—a movable pusher of the reinforcing device 13;
17—a tray of the brackets 14 of the reinforcing device 13;
18—a separator of the metal brackets 14 of the reinforcing device 13;
19, 20, 21, 22—walls of the hollow body 15 of the reinforcing device 13;
23—containers with 3D-printing materials;
24—pipelines;
25—a movable platform;
26—a control unit;
27—a link of the movement manipulator 5;
28—a multi-component platform;
29—an upper part of the multi-component platform 28;
30—a lower part of the multi-component platform 28;
31—outlet nozzles of the extruders 3;
32—electric heating elements on the outlet nozzles 31 of the extruders 3;
33—an inner cavity of the horizontal platform 28;
34—a movable manipulator of the mechanism for smoothing and treating surfaces with liquids 2;
35—horizontal movement motors of each of the extruders 3;
36—inclination movement motors of each of the extruders 3;
37—a motor of the polishing element 12;
38—a working surface of the polishing element 12;
39—a horizontal guiding bar for the horizontal movement motors 35 of the extruders 3;
40—additional dispersers for liquids.
41—printing (building) objects or objects of a building or a structure that has been built or the one being built;
42—a system for delivering building 3D-printing materials.
A, B, C—parts of the wall 20 of the hollow body 15 of the reinforcing device 13;
Z₁—longitudinal (vertical) axes of the extruders 3;
Z₂—a rotation axis of the multi-component platform 28;
X—a horizontal axis of the multi-component platform 28;
P—a longitudinal axis of the side extruder 10;
L—layers of the 3D-printing material which are formed by the extruders 3;
[symbol] —a layer of the 3D-printing material that is formed by the side extruder 10;
α—an inclination angle of the extruders 3;
β—an inclination angle of the side extruder 10;
γ—an inclination angle of the polishing element 12.

### DETAILED DESCRIPTION OF THE INVENTION

The technical solutions which are described in the revealed prior art provide building of a continuous wall or a wall composite of a house with a rough and non-treated outer surface in a form of layers of building mixtures deposited one on another which harden quickly and maintain the rough, non-treated outer surface. Hereinafter, the terms “wall”, “element or object of printing, building”, “elements of buildings and structures” mean a completed structure, a structural unit of a house or a structure. The term “wall” means a part of the wall composite, element of the building or structure. That is, the wall composite consists of a plurality of wall layers which may be made of a single or different building materials. Except for the walls, the system of operating members enables to print other various elements of buildings such as stairs, elements and details of facades, including decorative ones, balconies etc. In the same way, the proposed system enables to perform smoothing and treating of surfaces of said elements of buildings or structures. Both proposed embodiments of the invention are firstly aimed at creation of the system of members for 3D-printing that could provide building (printing) a continuous wall and other elements of buildings and structures, and, secondly, this system also must perform smoothing and treating the building elements during the building process simultaneously with the printing. To this end, the structure of the system of operating members provides for mounting and use of one or several extruders 3 which provide 3D-printing with a single building material or, in separate cases, with different building materials when from two to six extruders 3 are provided. During such printing, the rough, wavy (preferably, vertical) surface of the 3D-printed element is formed by convex contours of the layers of the applied material in a combination with recesses between them or with convexities outwards. In view of this, after any element is 3D-printed, it is always necessary to further treat the printed surface, namely, to fill the recesses between the layer of the applied material with the same material and to thrash (to smooth, to straighten) the surface, e.g., of the wall or to polish the convexities, the roughness of the wall. Usually, in the known 3D-printing technologies, there is a double work that lies in performing two separate processes being constructing the wall (other elements) and smoothing (straightening) the built surfaces, where the second process (of smoothing, straightening, applying a plaster) requires additional labor or mechanical resources, and, as a consequence, additional time, financial, and labor costs occur.

The invention is aimed at creation of two embodiments of the system of operating members for 3D-printing which, during printing of a next layer of the material, could provide a treatment (straightening, smoothing) of the wall surface, including between the already printed layers, immediately during the building process. Or, in other words, the present invention is aimed at creation of a system that could provide almost simultaneous performing, by a single device (being the system of operating members for 3D-printing), of two separate processes from the traditional building technologies being 3D-printing and smoothing and/or treatment of surfaces of the elements of buildings and structures.

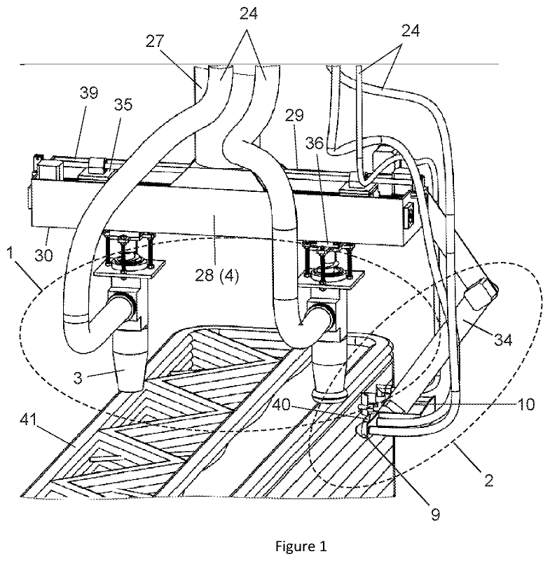

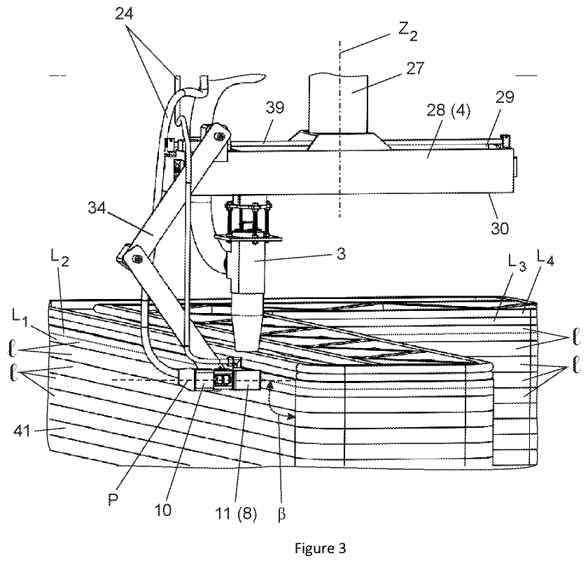

According to two embodiments of the invention, the proposed system comprises: the printing mechanism 1 that is made in a form of one or several extruders 3 and a mechanism 2 for smoothing and treating surfaces with liquids (FIG. 1) that, in turn, comprises the surface smoothing device 8 and at least one dispenser 9 for liquids (FIG. 3).

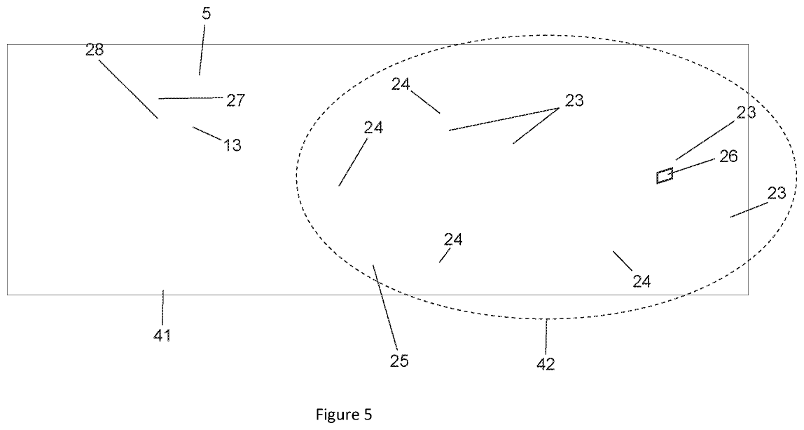

The one or each of the several extruders 3 is connected to the system 42 for delivering the building 3D-printing materials (FIG. 5) and configured to apply the plurality of the layers L of a single or different 3D-printing building materials deposited one on another. It should be noted that “the system of operating members for 3D-printing, for smoothing and treating surfaces” is a structural part of a general “3D-printing system” that implies a presence of other structural elements (which do not represent the subject matter of the present invention), including: a container or containers 23 with the 3D-printing material (materials), pipelines 24, a movable platform 25, a control unit 26, and other (FIG. 5). Thus, the movable platform 25 comprises the movement manipulator 5 (FIG. 5) which, acting together, move and “control” a general movement of the elements of “the system of operating members”. In both embodiments of the invention, the movement manipulator 5 comprises the movable link 27 that is connected to the structural connection element 4 that is made in a form of the multi-component platform 28 that is, in its upper part 29, connected to the link 27 of the movement manipulator 5 (FIGS. 1-4, FIG. 6) such that it is capable of performing a controlled rotation of the multi-component platform 28 in a horizontal plane around its own axis Z₂ (FIG. 3, 4, 6). According to the invention, the one or several extruders 3 and the mechanism 2 for smoothing and treating surfaces with liquids are simultaneously mounted on the multi-component platform 28 in such a way that they are capable of moving upwards, downwards, leftwards, rightwards, forward, backward, along diagonals, and in different directions of planes together with the multi-component platform 28 (together with the movement of the link 27 of the movement manipulator 5) relative to the object 41 to be printed (FIG. 1-7, 9, 10) directly during the 3D-printing and during smoothing and/or treating the surface of the object 41 to be printed with liquids (this movement of the extruders 3 and the mechanism 2 for smoothing and treating surfaces with liquids may be defined as “a first main operating movement”). In separate cases of both embodiments of the invention, the printing mechanism 1 may comprise from two to six extruders 3 (but without limitation to this number of extruders 3 only) with from two to six pipelines 24 (FIG. 1-3, 5, 6) respectively connected thereto, and these several extruders 3 are mounted on the multi-component platform 28 such that they are capable of applying the plurality of the layers L of one building material deposited one on another or several different building 3D-printing materials simultaneously.

Furthermore, the one extruder 3 or each of the several extruders 3 comprises:
its own motor 35 (FIG. 1, 4) that is intended to provide an additional independent horizontal movement of such extruder 3 along the horizontal axis X of the multi-component platform 28;
the inclination motor 36 (FIG. 1, 6) that is intended to provide an additional independent inclination of the extruder 3 relative to its own vertical axis Z₁ at an angle α of between 0° and 90°.

A non-standard feature of the field of 3D-building is that, in the proposed invention, the one extruder 3 or several extruders 3 with the motors 35, 36, by means of the at least one guiding element 39 (FIG. 1-4), are mounted in a system of the multi-component platform 28 such that during the operation the extruders 3 are capable of moving horizontally towards different directions along the multi-component platform 28 (this horizontal movement of the extruders 3 may be defined as “a second operating horizontal movement”). The guiding element 39 may be made in a form of one or several horizontal bars 39 which are longitudinally mounted and fixed within the multi-component platform 28, and the extruders 3 with the motors 35 are mounted on these particular guiding elements 39 in a movable fashion (i.e., they are not rigidly fixed). Also, the extruders 3 (due to the presence and operation of the motors 36) are capable of inclining each of the extruders 3 towards different directions relative to the own vertical axis Z₁ at an angle α of between 0° and 90° (this “inclination” movement of the extruders 3 may be defined as “a third operating inclination movement”).

Thus, a part of the operating members of the 3D-printing system in the form of the horizontally movable one extruder 3 with the motor 35 or several horizontally movable extruders 3 with the motors 35 which are mounted on the movable multi-component platform 28 that is, in turn, connected to the link 27 of the movement manipulator 5 such that the multi-component platform 28 is capable of rotating in the horizontal plane around its own axis Z2 and capable of performing movements towards different directions, upwards and downwards, enable to perform building of the objects 41 to be printed of the buildings and structures by the 3D-printing method with several layers L, with a single building material or, in separate cases, with several different building materials (when from two to six extruders 3 are present on the multi-component platform 28 with various pipelines connected thereto with various building materials supplied along them). The application of the layers L of several various building materials may be performed in a sequential or simultaneous fashion. These various building materials may represent: a concrete mixture (e.g., that is supplied to the two extruders 3), a thermal-insulating foam (that is supplied to the one extruder 3), waterproof mixtures, mortars and liquids, a reinforcing material being a liquid plastic, a polymer (that is fed to the one or two extruders 3), other. In such a way, “the wall composite” is formed (printed) from, e.g., concrete, foam, polymer, but without limitation thereto.

The described structure, during its operation, enables to perform at least two types of independent movements of the extruders 3 relative to the elements of buildings and structures, namely:
the first main operating movement of the one or each of the several extruders 3 together with the multi-component platform 28 in a space (forward-backward-leftwards-rightwards-upwards-downwards-in a circle);
the second operating horizontal movement of the one or each of the several extruders 3 in two different directions (nominally, leftwards, rightwards) by means of the one or several motors 35 along the guiding element 39 within the multi-component platform 28 (e.g., when it is preferably in a dynamic state of the first main movement together with the multi-component platform 28 relative to the object 41 to be printed), and, therefore, the second operating horizontal movement of the extruders 3 towards different directions (nominally, leftwards, rightwards) occurs also relative to the element of the building or structure (the object 41 to be printed) by the extruders 3.

Such structural solution makes both embodiments of the system of operating members more “flexible”, maneuverable, and universal in terms of a possibility of a certain mounting or necessary spatial movement of the extruders 3 relative to the objects 41 to be printed of buildings or structures being printed. At least two independent “sources” of providing the movement to the extruder 3 or extruders 3 (together with the multi-component platform 28 under action of the link 27 of the manipulator 5 and under action of the motors 35) provide a precise control of all the spatial movements and positions of the extruder 3 or several extruders 3 relative to the object to be built that, in turn, enables to perform a more quick, precise, and effective 3D-printing.

Furthermore, the presence of its own additional inclination motor 36 in each of the extruders 3 enables to perform an angular inclination of each of the extruders 3 relative to its own axis Z₁ at the angle α of between 0° and 90°, and, thus, relative to the surface of the object 41 to be printed (such angular inclinations of the extruders 3 may occur simultaneously with the already described first and the second movements of the extruders 3 or independently from them). A change of the inclination angle α of the extruders 3 along the axis Z₁ on the guiding element 39 (e.g., on the horizontal guiding bar 39) of the multi-component platform 28 enables to print elements in a form of protrusions and recesses of relatively even surfaces of the objects 41 to be printed (e.g., to print elements of faces, balconies, steps, other). Such non-standard result of operation of the two embodiments of the system is achieved by the fact that, e.g., when passing along the horizontal guiding bar 39 having one trajectory, the first extruder 3 “takes up” the inclination angle α of 10° (due to the operation of its own inclination motor 36), while the second extruder 3 arranged on the same bar 39 “takes up” another inclination angle α of 15° (also due to the operation of its own inclination motor 36), thereby moving along a single shared trajectory, but having different slope relative to each other, the second extruder 3 immediately after the first extruder 3 prints the convexity on the surface of the object 41 to be printed (i.e., it prints a projecting layer), thereby forming a diagonal surface. This process may be performed in a reverse fashion as well, thereby allowing to print a recess on the surface of the object 41 to be printed. Such 3D-printing at the inclination angle α along the axis Z₁ allows to print complex curved elements of buildings quickly. Therefore, such non-standard and non-obvious structural solution (the presence of the inclination motor 36 in each of the extruders 3, thereby allowing, regardless of other extruders 3, to change the inclination angle α of each of the extruders 3, or in case of one extruder 3, to change the inclination angle α directly during the process of printing each next layer L) in a combination with other details of the system of operating members for 3D-printing enables to provide a quick printing of complex protruding and recessed elements of the objects 41 to be printed (protrusions and recesses having any shape on the main horizontal or on another surface of the elements of buildings or structures being printed) and to perform smoothing and treatment of their surfaces, if necessary.

Also, the change of the inclination angle α of the extruders 3 along the axis Z₁ (due to the operation of the inclination motors 36), e.g., the inclination of the extruders 3 at the angle of 90° relative to its own vertical, “sets” the extruders 3 into a horizontal position and allows the extruders 3 to print horizontal surfaces, however, to this end, usually it is necessary to use a fast-hardening building material.

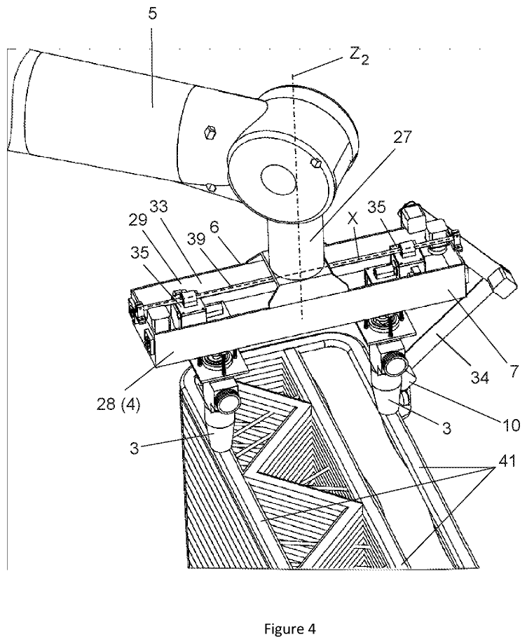

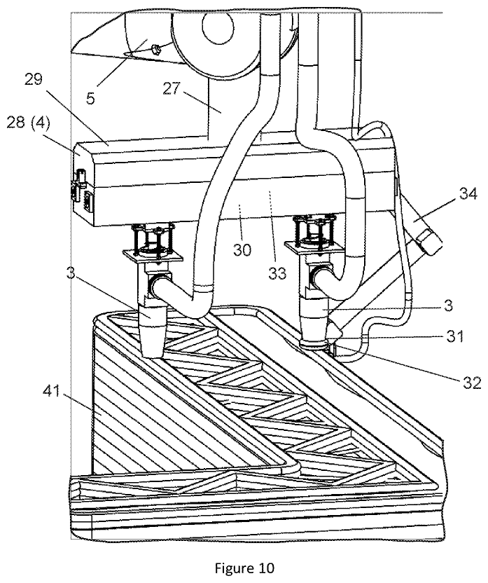

The multi-component platform 28 (FIG. 1-4, 6), in the structure of both embodiments of the invention, is rather complex and important basic detail with the operating members of the system mounted and moving thereon (the extruders 3, the mechanism 2 for smoothing and treating surfaces with liquids, other). It shall be understood that depending on the number of the extruders 3 and on other technological factors, the multi-component platform 28 may be formed from various details and assemblies which number, shape, and functional purpose may be different in various cases. For example, in separate cases of any of the two embodiments of the invention, the multi-component platform 28 may be made in a form of a horizontally arranged U-shaped profile, wherein the upper part 29 of the multi-component platform 28 is closed, while the lower part 30 is opened (FIG. 10, 11). Side and upper planes of the U-shaped profile form the inner cavity 33 of the multi-component platform 28 in which the at least one guiding element 39, e.g., in a form of the horizontal guiding bar 39 for the motors 35 for the horizontal movement of the extruders 3, is mounted. In other separate cases, the multi-component platform 28 may be made in a form of a horizontally arranged II-shaped profile, wherein the upper part 29 and the lower part 30 of the multi-component platform 28 are opened (FIGS. 1-4). The horizontal planes (side walls 6, 7) of the II-shaped profile form the inner cavity 33 of the multi-component platform 28 in which the at least one horizontal guiding bar 39 for the motors 35 for the horizontal movement of the extruders 3 is mounted (FIG. 4).

It should be noted that except for mounting the extruders 3 on the multi-component platform 28 and connecting the multi-component platform 28 to the link 27 of the movement manipulator 5, the multi-component platform 28 is also intended to mount thereon other details and elements of the system of operating members for 3D-printing of elements of buildings and structures and for smoothing and treating their surfaces with liquids. An unexpected feature is that depending on future technical tasks regarding building of the object, the structure and the mounting location of the multi-component platform 28 in the system allows to mount thereon those particular number of the extruders 3 and those particular details of the mechanism 2 for smoothing and treating surfaces with liquids which are expedient and necessary particularly for building the defined object.

In the first embodiment of the invention, the mechanism 2 for smoothing and treating surfaces with liquids further comprises a side extruder 10 (FIG. 1, 3, 4, 6). Therewith, the surface smoothing device 8 is made in a form of a smoothing plate 11 (FIG. 3). Therefore, according to the first embodiment of the invention the mechanism 2 for smoothing and treating surfaces with liquids consists of: the side extruder 10, the smoothing plate 11, and the liquid dispenser 9. All these elements of the mechanism 2 for smoothing and treating surfaces with liquids (the side extruder 10 (FIG. 1, 3, 4), the smoothing plate 11 (FIG. 3), and the liquid dispenser 9, FIG. 1) are mounted and fixed to the multi-component platform 28 (e.g., from a side of an outer vertical surface of the wall of the element being built, but without limitation to this position) by means of the movable manipulator 34 of the smoothing mechanism that is freely movable towards different directions and in different planes. It is understood that the movable manipulator of the smoothing mechanism 34 may have several arms, links which are capable of moving by means of several motors.

The side extruder 10 is connected to the system 42 for delivering the building 3D-printing materials and is configured to apply one or several additional layers [symbol] (FIG. 3) of the 3D-printing material onto surfaces (preferably, onto side surfaces) of the at least two layers L preliminary printed by the extruders 3 (FIG. 3 depicts two preliminary printed layers L₁ and L₂ with the additional layer [symbol] applied by the side extruder 10, as well as it depicts layers L₃ and L₄ which are being printed by the extruders 3 with no additional layer e applied thereon yet). That is, the side extruder 10 applies the at least one additional layer [symbol] onto the side surfaces of the new layers L₁ and L₂ printed by the extruders 3 in order to fill the recesses and roughnesses formed, e.g., between several new layers L printed by the extruder 3, with the building material. The smoothing plate 11 is arranged such that it is capable of smoothing the additional layer or several layers [symbol] of the 3D-printing material in a course of the movement and printing of the side extruder 10. The system of operating members, according to the first embodiment, operates as follows. The printing mechanism 1 (in the form of the single extruder 3 or several extruders 3) prints the layers L (in FIG. 3, they are shown as L₁ and L₂). A concrete mixture, polystyrene, foam, aerogel, polyether, polystyrene, fibrous concrete, polypropylene fibrous concrete, nylon fibrous concrete, gypsum, gel powder and other building polymers and materials of such type which are known and understood for a skilled person may be used as the 3D-printing material. Directly at the moment of printing the layers L₁ and L₂, the liquid dispenser 9, the side extruder 10, and the smoothing plate 11 are in a passive “waiting” state. The extruder 3 or each of the extruders 3, preferably, apply the 3D-printing material at a right angle relative to the horizontal surface of the object 41 to be printed (if they are not active and the inclination motors 36 do not operate; it is possible to state that nominally one or each inclination motor 36 “operates” to arrange the extruders 3 relative to the horizontal surface of the object 41 to be printed), i.e. the entire axis Z₁ of the extruder 3 or the axis Z₁ of each of the extruders 3 during the printing is preferably perpendicular to the layer L being printed. When the layers L₁ and L₂ has been already printed, along the movement path of the multi-component platform 28 with one or several extruders 3 which print the next layer L₃, the side extruder 10 is “activated” and applies the layer [symbol] of the material onto the side surface of two, already provided lower layers L₁ and L₂ (preferably, the layer [symbol] of the material is applied by the side extruder 10 into the formed side recess between the already provided layers L₁ and L₂). Therewith, the smoothing plate 11, when moving (by means of the movable manipulator 34 of the smoothing mechanism) simultaneously with the side extruder 10 along the surface of the object 41 to be printed and, in particular, touching, at a certain angle and with a certain pressure, this surface (e.g., the vertical surface of the wall) and the newly applied layer e, by means of dispensing the building material (the layer [symbol] ) smooths this layer [symbol] of the building material newly applied by the side extruder 10 The liquid dispenser 9, along the movement path of the side extruder 10 and the smoothing plate 11, also moves (by means of the movable manipulator 34 of the smoothing mechanism) simultaneously with these devices and, if necessary, dispenses the liquid or a solution of liquids onto the surface of the building element in order to provide a required humidity and plasticity to the layers L and [symbol] of the material to be smoothed. For example, water is used as the liquid to be dispersed, but without limitation thereto. It should be noted that in the process of the operation of the side extruder 10, its longitudinal axis P (FIG. 3) may be arranged at the angle β of between 0° and 180° relative to the object 41 to be printed (preferably, relative to its side, vertical surface) with a possibility of changing (by means of the movable manipulator 34 of the smoothing mechanism) this angle β during 3D-printing of the elements of buildings and structures. The accurate value of the angle β and the position of the side extruder 10 at a certain moment of time depend on characteristics of the concrete mixture and relief characteristics of the outer surface of the adjacent printed layers L (in other words, they depend on a “waviness” degree of the surface of the element being built, e.g., the vertical wall). Moves and position of the multi-component platform 28, of the movable manipulator 34 of the smoothing mechanism and of the entire mechanism 2 for smoothing and treating surfaces with liquids (the side extruder 10, the smoothing plate 11, and the liquid dispenser 9) are “controlled” by the control unit 26.

The described process of smoothing the surface (in the first embodiment of the invention) is repeated during the 3D-printing of each next layer L. After the extruder 3 or each of the extruders 3 has printed the layer L, the system of operating members, e.g., passes along two upper printed layers L twice (in FIG. 3, they are shown as L₁ and L₂), wherein the liquid dispenser 9, the side extruder 10, and the smoothing plate 11 are in the operating state, while the extruder 3 or each of the extruders 3 may be in the passive state, however, preferably, the extruders 3 continue to print the next layers L (in FIG. 3, they are shown as L₃ and L₄). The side extruder 10 prints the additional layers [symbol] in the recesses between the layers L₁ and L₂, and then, the next layer e in the recesses between the layers L₃ and L₄, when they have been already printed (i.e., the layers [symbol] “overlay” onto the side faces of the layers L), the liquid dispenser 9, if necessary, wets the surface to be smoothed, while the smoothing plate 11 smooths the newly applied layers [symbol] . The passive or active state of the side extruder 10, of the smoothing plate 11, of the liquid dispenser 9 and/or of the extruder 3 or each of the extruders 3 are provided due to their provision and mounting on the multi-component platform 28 with a possibility of changing their position relative to the object 41 to be printed being built, and these processes are “controlled” by the control unit 26 (of the entire 3D-printing system) which is understood for a skilled person. As a result, the entire outer surface of the 3D-printed building object (e.g., of the vertical wall) along which the mechanism 2 for smoothing and treating surfaces with liquids in the form of the side extruder 10, the smoothing plate 11, and the liquid dispenser 9 “were operating” during printing is even and smooth. Therefore, the structure of the first embodiment of the invention allows to build elements of buildings and structures by the 3D-printing method and, at the same time, to perform the process of smoothing and treating the surface (in particular, of at least one vertical surface of the element) of the object 41 to be printed in a single operation cycle of the system. That is, the structure of the system allows to achieve the automatic performing of the “additional treatment” of the printed elements of buildings or structures without involvement of additional labor or mechanical resources (after completion of the 3D-printing and additional treatment). This results in that the operation of the system allows to achieve the reduction of time, financial, and labor costs and, at the same time, to increase the quality of the printed elements of buildings and structures. Also, as it has been already mentioned, the first embodiment of the system also allows to print complex protruding and recessed elements of buildings and structures quickly, and to perform the treatment and smoothing of surfaces of these elements, if necessary.

Furthermore, when using several extruders 3, the structure of the first embodiment of the invention also allows to build the elements of buildings and structures by the 3D-printing method in several layers and several building materials, as well as, at the same time, to perform the process of smoothing and treating the surfaces of the elements being built in the single operation cycle of the system.

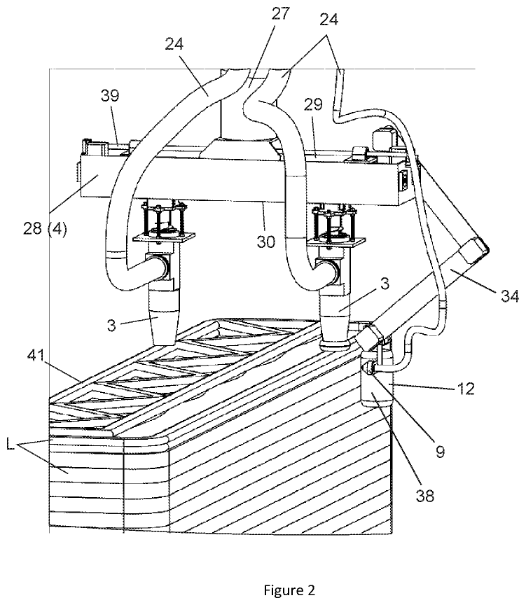

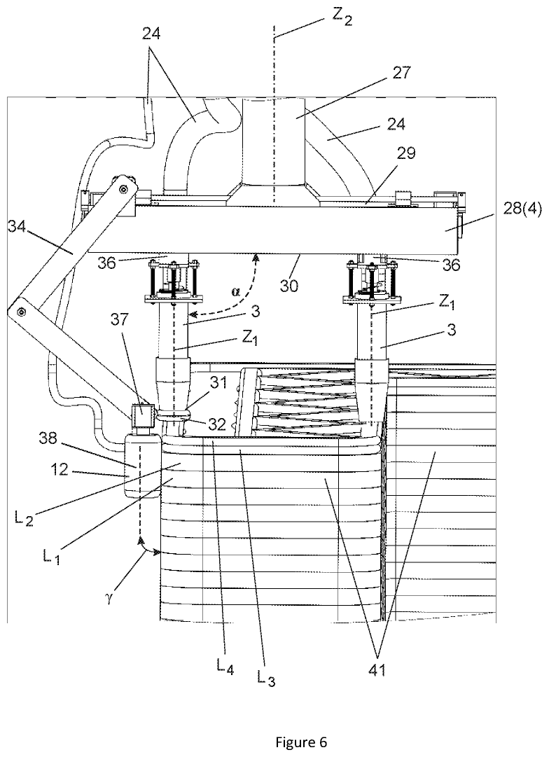

In the second embodiments of the invention, the 3D-printing process occurs in the same way as in the first embodiment, however, the process of smoothing and treating the surfaces occurs differently. In the second embodiment of the invention, the mechanism 2 for smoothing and treating surfaces with liquids is made in the form of the polishing element 12 (FIG. 2, 6, 9) with the motor 37 (FIG. 6). All the elements of the mechanism 2 for smoothing and treating surfaces with liquids of the second embodiment of the structure: the polishing element 12 and the liquid dispenser 9 are mounted and fixed to the multi-component platform 28 by means of the movable manipulator 34 of the smoothing mechanism (FIG. 2, 6, 9). The movable manipulator 34 of the smoothing mechanism, its legs, links, and motors are provided and mounted on the multi-component platform 28 in a free movable fashion in different planes such that the working surface 38 of the polishing element 12 is arranged such that it is possible to change the inclination angle γ (FIG. 6) of the polishing element 12 and its working surface 38 relative to the surface of the object 41 to be printed during operation of the system of operating members. The smoothing and treatment of the outer surfaces of two last printed layers L (in FIG. 6, they are shown as L₁ and L₂) which have been newly printed by the extruders 3 may be performed by means of, e.g., polishing (planishing) by the polishing element 12 that in various cases may be made in the form of, e.g., a planishing disc, but without limitation thereto. When the layers L₁ and L₂ have been already printed, along the movement path of the extruder 3 or extruders 3 that or each of which prints next layers L (in FIG. 6, they are shown as the layers L₃ and L₄), the active polishing element 12 (e.g., the planishing disc 12) straightens the outer surface of two lower already printed layers L₁ and L₂ (FIG. 6). Along the movement path of the polishing element 12, the liquid dispenser 9 also moves simultaneously with the polishing element 12 (on the movable manipulator 34 of the smoothing mechanism) and, if necessary, dispenses the liquid or the solution of liquids onto the surface of the object 41 to be printed in order to wet the surface directly during the polishing process. For example, water is used as the liquid to be dispersed, but without limitation thereto. The process is repeated during the 3D-printing of each next layer L. After the extruder 3 or each of the extruders 3 has printed the layer L, the system of operating members, e.g., passes along two upper printed layers L twice (L₁ and L₂ in FIG. 6), wherein the mechanism 2 for smoothing and treating surfaces with liquids (the polishing element 12, the liquid dispenser 9, the movable manipulator 34 of the smoothing mechanism) are in the operating state, i.e., they “operate”, while the extruders 3 may be in the passive state, however, preferably, the extruders 3 continue to print the next layers (L₃ and L₄ in FIG. 6). As a result of such operation of the structure of the second embodiment of the invention, the outer surface of the 3D-printed element of building or structure along which the polishing element 12 and the liquid dispenser 9 “were operating” is treated and smoothed once it has been constructed.

Therefore, the structure of the second embodiment of the invention allows to build elements of buildings and structures by the 3D-printing method and, at the same time, to perform the process of smoothing, treating the at least one vertical surface of the object 41 to be printed in a single operation cycle of the system. That is, the structure of the second embodiment of the system allows to achieve the automatic performing of the “additional treatment” of the printed elements of buildings or structures without involvement of additional labor or mechanical resources (after completion of the 3D-printing and additional treatment). This results in that the operation of the system allows to achieve the reduction of time, financial, and labor costs and, at the same time, to increase the quality of the printed elements of buildings and structures. Also, the second embodiment of the system allows to print complex protruding and recessed elements of buildings and structures quickly.

Furthermore, when using several extruders 3, the structure of the second embodiment of the invention also allows to build the elements of buildings and structures by the 3D-printing method in several layers and several building materials, as well as, at the same time, to perform the process of smoothing and treating the surfaces of the elements being built in the single operation cycle of the system.

The original and non-standard technical solution in the structures of both embodiments of the invention lies in that the printing mechanism 1 (in the form of the extruders 3) and the mechanism 2 for smoothing and treating surfaces with liquids are simultaneously mounted on the single multi-component platform 28 such that they are capable of moving simultaneously with the multi-component platform 28 towards different spatial directions relative to the object 41 to be printed, thereby allowing, at the same time with the 3D-printing process, to use the side extruder 10 or the polishing element 12, the liquid dispenser 9, and the smoothing plate 11 for treating/smoothing the surfaces of the newly printed elements of the object 41 to be printed without involving additional labor, time, and material resources.

In separate cases of both embodiments of the invention, the electric heating element 32 may be mounted at an outlet nozzle 31 of one extruder 3 or at each of outlet nozzles 31 of each of the several extruders 3, the electric heating element has the same shape as the shape of the inner walls of the outlet nozzle 31 (FIG. 6, 10). During supplying the building mixture to the extruder 3, the electric heating element 32, during heating thereof, performs a quick discharge of the humidity from the building mixture directly during the printing process. Preferably, this concerns the concrete mixture, but without limitation thereto. Such solution enables to transport the building mixture along the pipelines 24 with low density in order it could be transported along the pipelines 24 in a better way and until the end of the outlet nozzles 31 of the extruders 3. Therewith, when exiting the nozzle 31, the printing mixture loses the humidity, thereby allowing it to be laid down in more even layers without setting and to achieve a quicker hardening. When using the electric heating element 32 in each of the embodiments of the system of operating members for 3D-printing, it is enabled to achieve: a quicker movement; a quicker hardening of the printed element; to reduce the setting of the printed element; to increase the rigidity of the printed element.

In separate cases of both embodiments of the system of operating members for 3D-printing of elements of buildings and structures and for smoothing and treating their surfaces with liquids, the mechanism 2 for smoothing and treating surfaces with liquids, expect for the presence of one liquid dispenser 9, may further comprise one or several additional liquid dispensers 40 (FIG. 1) which could be configured to dispense identical or different liquids. Each of the additional liquid dispensers 40 may be mounted and fixed to the multi-component platform 28 by means of the movable manipulator 34 of the smoothing mechanism (FIG. 1-6) that is freely movable in different planes. Also, each of the additional liquid dispensers 40 may be mounted and fixed to the multi-component platform 28 by means of other structural elements. This allows to use different liquids for treatment of the built object 41 to be printed in a more efficient way through different dispensers 9 (main) and 40 (additional), e.g., water, paint, waterproof mixture, plaster mixture and other.

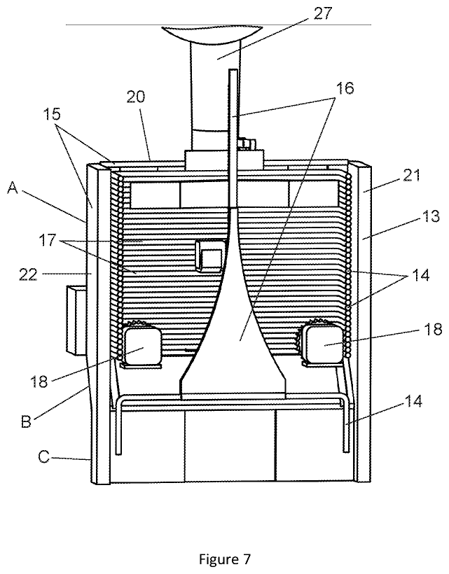

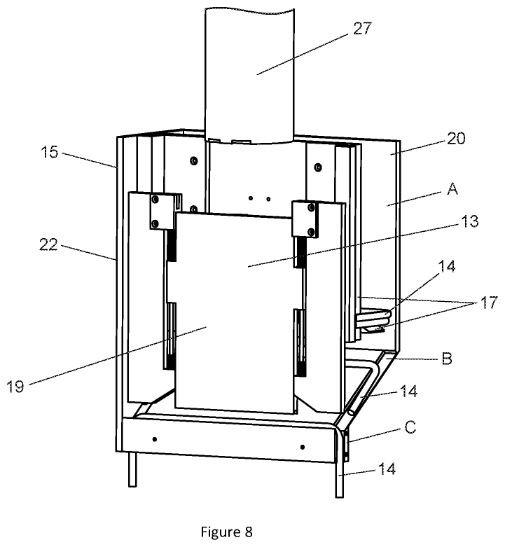

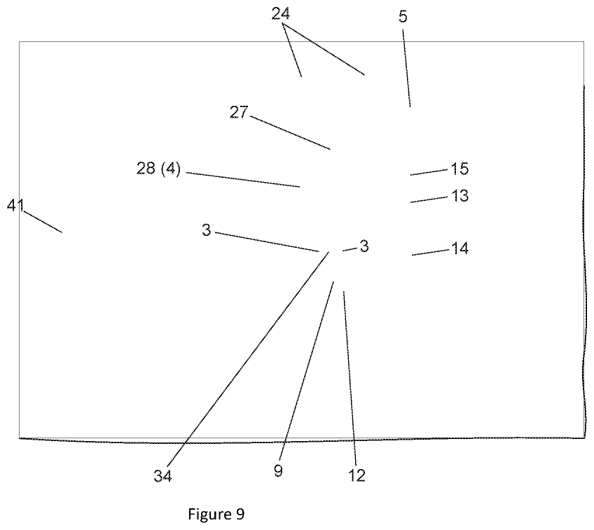

In separate cases of both embodiments of the invention, the system of operating members for 3D-printing of elements of buildings and structures and for smoothing and treating their surfaces with liquids further comprises the device 13 for reinforcing (FIG. 7-9, 11) elements of buildings and structures (objects 41 to be printed), including for reinforcing with the brackets 14. In separate embodiments of the invention, the reinforcing device 13 may be mounted on the movement manipulator 5 (FIG. 9) or on a separate robot-manipulator (not shown in the drawings) that, in turn, may be mounted on the movable platform 25. The reinforcing device 13 is made in the form of the hollow housing 15 that is formed by the walls 19, 20, 21, 22 (FIG. 7, 8, 11), wherein the wall 19 is made straight, and the wall 20 is formed by the parts A, B, C (FIG. 7, 8), wherein the parts A and C are arranged vertically and coupled between each other by the part B that is arranged inclined at an angle relative to the walls A and C, while the parts A and B are mounted, e.g., at an angle in a range between 90° and 170° to each other. The hollow housing 15 has the tapered lower part. The movable pusher 16, the tray 17 with the brackets 14, and the separator 18 are mounted inside the hollow housing 15 (FIG. 7, 11). The movable pusher 16 is vertically movable along the wall 19. The tray 17 is mounted along the part A of the wall 20 and abuts against the separator 18. The brackets 14 are pre-inserted into the tray 17. The reinforcing device 13 (that is “controlled” by the control unit 26), by means of the separator 18, separates the brackets 14 from a group of the brackets 14, and by means of the movable pusher 16, it pushes each required bracket 14 to the layers L of the building element which are newly applied by the extruders 3. Therefore, at the same time with the process of 3D-printing and smoothing the surface, the system is able to perform the process of reinforcing the object 41 to printed.

The stated additional structural features of each of the two embodiments of the invention enable to enhance and to vary the achievement of the technical effect, however, they do not pose any limitation onto manufacturing various modifications of the embodiments of the invention which improve a certain feature of the system of the operating members for 3D-printing that is associated or not associated with the claimed technical effect.

Generally, both structures of the embodiments of the system of operating members for 3D-printing of elements of buildings and structures and for smoothing and treating their surfaces with liquids, except for achievement of the main technical effect, further allow civil architects and constructors to solve more complex designer solutions, namely, to create and to build buildings and structures quickly and efficiently (including with several different building materials simultaneously) which have complex and various non-standard geometric, configuration shapes of elements of buildings and structures, while, at the same time, treating (smoothing, polishing and/or coating with different liquids) the surfaces of the built elements.

### Best Examples of Implementation of Embodiments of the Invention

Static description of the structures.

The system of operating members for 3D-printing of elements of buildings and structures and for smoothing and treating their surfaces with liquids is a part of a larger entire system for 3D-printing buildings and structures, the system comprising: the container 23 or several containers 23 (FIG. 5) with the 3D-printing materials (for concrete, foam etc.) and for liquid solutions (e.g., for water, waterproof mixtures, paints, etc.), the pipelines 24 (FIG. 1-3, 5, 6), the movable platform 25, the control unit 26 (FIG. 5) having a software. The control unit is mounted, e.g., on any of the containers 23, but without limitation thereto. The pipelines 24 connect the containers 23 and the working members of the system (one or several extruders 3, the side extruder 10, the liquid dispensers 9, 40). The pipelines 24 are intended to transport the building mixtures and liquids to building (printing) sites, and, together with the containers 23 and corresponding pumps and with other necessary details, they form the system 42 for delivering the building 3D-printing materials (FIG. 5). Therewith, each of the extruders 3, 10 or each dispenser 9, 40 is connected to the corresponding container 23 by means of its own pipeline 24. The extruders 3, 10 may receive the building mixture from the same or from different containers 23. The dispenser 9, 40 may receive the liquid from the same or from different containers 23. It shall be understood that the entire system for 3D-printing of buildings and structures comprises all necessary details, assemblies, and apparatuses (motors, pumps, connection details, taps, dampers etc.) for its effective operation. The movable platform 25 comprises at least one movement manipulator 5 which the link 27 is connected to (FIG. 5). The entire system of operating members for 3D-printing of elements of buildings and structures and for smoothing and treating their surfaces with liquids is specifically connected to the link 27 (FIG. 5).

The system of operating members, according to the first embodiment of the structure, comprises main elements: the printing mechanism 1 that is made in the form of one or several extruders 3; the connection element 4 for connecting the printing mechanism 1 to the movement manipulator 5 that is made in the form of the multi-component platform 28 that, in its upper part 29, is connected to the link 27 of the movement manipulator 5 such that the multi-component platform 28 is capable of rotating in the horizontal plane around its own axis Z₂ (FIG. 1, 3, 4); the mechanism 2 for smoothing and treating surfaces with liquids is made in the form of the additional side extruder 10, the smoothing plate 11 (it represents the surface smoothing device 8), and the liquid dispenser 9 (FIG. 1, 3, 4) which are mounted and fixed to the multi-component platform 28 by means of the movable manipulator 34 of the smoothing mechanism (FIG. 1, 3, 4) such that these details are capable of moving together with the multi-component platform 28 relative to the object 41 to be printed directly during the 3D-printing and during the smoothing and treating the surfaces of the elements of buildings and structures with liquids.

In separate implementation cases of each of the two embodiments of the invention, from two to six extruders 3 may be mounted on the multi-component platform 28 (e.g., two extruders 3, FIG. 1, 2, 4, 6, 9, 10), but without limitation thereto. One of the extruders 3 or several extruders 3 are configured to apply the plurality of the layers L deposited one on another with one or several different building materials (in case if several extruders 3 are provided) simultaneously or alternately. In separate implementation cases of each of the two embodiments of the invention, the electric heating elements 32 may be mounted on the outlet nozzles 31 of the extruders 3, each of the electric heating elements having the same shape as the shape of the inner walls of the outlet nozzle 31 of the corresponding extruder 3 (FIG. 6).

Each of the extruders 3 comprises the motor 35 (FIG. 1, 4) that is intended to provide

an independent horizontal movement of each of the extruders 3 towards different directions (leftwards/rightwards relative to the multi-component platform 28) along the horizontal axis X (FIG. 4) of the multi-component platform 28. Also, each of the extruders 3 comprises the inclination motor 36 relative to the own longitudinal (vertical) axis Z₁ at the angle α of between 0° and 90° (FIG. 6). Thus, each of the extruders 3 with the motors 35, 36 is mounted on the multi-component platform 28 such that each extruder 3 is capable of moving horizontally towards different directions along the multi-component platform 28 relative to the object 41 to be printed due to the operation of the motors 35, as well as capable of inclining each of the extruders 3 towards different directions relative to the own vertical axis Z₁ at the angle α of between 0° and 90° due to the operation of the motors 36. The motors 35, 36 of the extruders 3 are controlled by the control unit 26. In both embodiments of the invention, the structure of the multi-component platform 28 may comprise many various details, including the horizontal guiding bar 39 (FIG. 1-4) for the motors 35 of the horizontal movement of all of the extruders 3.

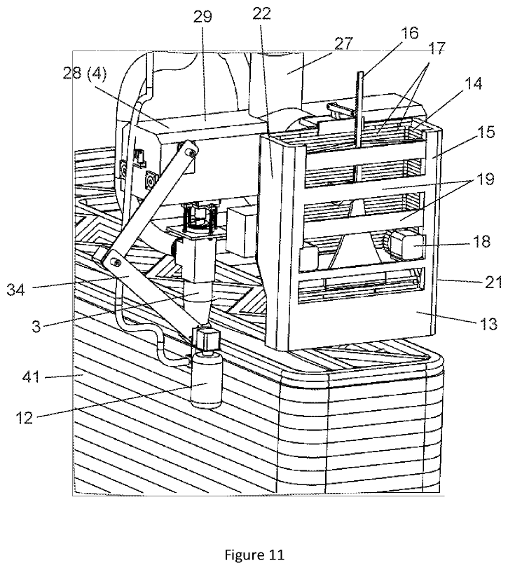

In separate implementation cases of both embodiments of the invention, the multi-component platform 28 may be made, e.g., in the form of the horizontally arranged U-shaped profile (FIG. 9-11), where the upper part 29 of the multi-component platform 28 is closed, the lower part is opened, and the planes of the U-shaped profile (including the side walls 6, 7 of the multi-component platform 28) form the inner cavity 33 of the multi-component platform 28, wherein the at least one horizontal guiding bar 39 for one or several motors 35 of the horizontal movement of the extruders 3 is mounted. In case of such design of the multi-component platform 28, the lower opened part 30 of the plane of the U-shaped profile “allows” to perform a free movement and inclination of the extruders 3.

In other separate implementation cases of the first and the second embodiments of the invention, the multi-component platform 28 may be made, e.g., in the form of a horizontally arranged II-shaped profile, wherein the upper part 29 and the lower part 30 of the multi-component platform 28 are opened (FIG. 1-4, 6), while the planes of the II-shaped profile (the side walls 6, 7 of the multi-component platform 28) form the inner cavity 33 of the multi-component platform 28, wherein the at least one horizontal guiding bar 39 for one or several motors 35 of the horizontal movement and inclination of the extruders 3 is mounted. In such cases, the lower part 30 of the multi-component platform 28 is completely opened.

In the first embodiment of the invention, the movable manipulator 34 of the mechanism for smoothing and treating surfaces with liquids (with the side extruder 10 (FIG. 1, 3, 4), the smoothing plate 11 (FIG. 3), the liquid dispenser 9, (FIG. 1) mounted thereon) may have several movable legs and the corresponding motors. The movable manipulator 34 of the smoothing mechanism is made and may be mounted on one of the side walls 6 or 7 of the multi-component platform 28 (FIG. 4) such that it is freely movable (under control by the control unit 26) in different planes in such a way that the longitudinal axis P of the side extruder 10 may be arranged at the angle β of between 0° and 180° (FIG. 3), preferably, relative to the side, vertical surface of the object 41 to be printed (e.g., relative to the outer vertical surface of the wall being built) with a possibility of changing this angle β during the 3D-printing and smoothing and treatment of the surfaces of the elements of buildings and structures with liquids. The movable manipulator 34 of the smoothing mechanism is also capable of moving together with the multi-component platform 28, as well as the legs and the links of the manipulator 34 move independently of the multi-component platform 28 and by means of the motors of the manipulator 34 (not shown in the drawings). The side extruder 10 is connected to one of the containers 23 through the pipelines 24, i.e., to the system 42 for delivering the building 3D-printing materials (FIG. 5), and it is configured to apply one or several additional layers [symbol] of the 3D-printing material onto the surfaces (preferably, onto the side surfaces) of the at least two layers L preliminary printed by the extruder 3 or by several extruders 3 (preferably, into the side recesses between two lower layers L already made by the extruder 3, in FIG. 3, they are shown as L₁ and L₂). The smoothing plate 11 is arranged such that it is capable of smoothing the additional layer or layers [symbol] of the 3D-printing material in a course of the movement and printing of the side extruder 10. The liquid dispenser 9 may be mounted upstream of the side extruder 10 or between the side extruder 10 and the smoothing plate 11, or downstream of the smoothing plate 11 (FIG. 1, 3). The liquid dispenser 9 is connected to one of the containers 23 through the pipelines 24.

In the second embodiment of the invention, the multi-component platform 28 and the printing mechanism 1 in the form of one or several extruders 3 are made in the same way as in the first embodiment. However, in the structure of the second embodiment of the invention, the mechanism 2 for smoothing and treating surfaces with liquids is made in the form of the polishing element 12 with the motor 37 (FIG. 2, 6, 9) and the liquid dispenser 9 which are mounted and fixed to the multi-component platform 28 by means of the movable manipulator 34 of the smoothing mechanism (FIG. 2, 6, 9, 11) that may have several movable legs, motors (FIG. 6). The movable manipulator 34 of the smoothing mechanism of the second embodiment is made and may be mounted on one of the side walls 6, 7 of the multi-component platform 28 such that it is freely movable (under control by the control unit 26) in different planes in such a way that the polishing element 12 and its working surface 38 (FIG. 2, 6) are arranged with a possibility of changing the inclination angle γ of the polishing element 12 and its working surface 38 relative to the surface (preferably, the vertical one) of the object 41 to be printed during operation of the system of operating members (FIG. 6). Various planishing, polishing devices (discs, rolls, other) may be used as the polishing element 12. In the second embodiment of the system of operating members, the liquid dispenser 9 may be mounted upstream of the polishing element 12 (FIG. 2) or downstream of the polishing element 12. The liquid dispenser 9 is connected to the containers 23 through the pipelines 24.

In separate cases of each of the two embodiments of the invention, the mechanism 2 for smoothing and treating surfaces with liquids may further comprise one or several additional liquid dispensers 40 (FIG. 1), each of them may be fixed to the multi-component platform 28 by means of the movable manipulator 34 of the smoothing mechanism.

In separate implementation cases of each of the embodiments of the invention, the structure of the system of operating members for 3D-printing of elements of buildings and structures may further comprise the reinforcing device 13 for reinforcing the elements of buildings and structures with the brackets 14 (metal or other ones) (FIG. 7-9, 11), and the structure thereof has been described previously in detail. In separate embodiments of the invention, the reinforcing device 13 may be mounted on the movement manipulator 5 (FIG. 9, 11) or on a separate robot-manipulator (not shown in the drawings) that, in turn, may be mounted on the movable platform 25.

Description of operation of the two embodiments of the invention and examples of industrial use.

The system of operating members of both embodiments of the invention may be mounted on a portal-type or other building 3D-printer or on the manipulator 5, but without limitation thereto. Most commonly, the six-axis manipulator 5 mounted on the movable platform 25 is used as the manipulator 5 (FIG. 5). The system of operating members for 3D-printing of elements of buildings and structures and for smoothing and treating their surfaces with liquids is fixed on the manipulator 5 by means of a movable connection of the multi-component 28 to the link 27 of the manipulator 5. The extruders 3, 10 are connected to the containers 23 with various types of the 3D-printing materials by means of the pipelines 24 (FIG. 5). The liquid dispensers 9 and 40 are connected to the containers 23 by means of the pipelines 24 as well. The 3D-printing material or various types of the 3D-printing material, as well as liquids, solutions are continuously supplied to the extruders 3, 10 and to the dispensers 9, 40 respectively by means of automated or mechanical supplying means which may be, e.g., pumps. Transportation of various types of the material to the extruders 3, 10 and liquids, solutions to the liquid dispensers 9, 40 from the containers 23, movement of the movable platform 25, performing of the 3D-printing by the printing mechanism 1, and smoothing/treatment of the surfaces of the printed layers L by the mechanism 2 for smoothing and treating the surfaces with liquids are carried out by means of the control unit 26. The control unit 26 is a technological device (system) that functions owing to a software that is specifically created and loaded into the control unit 26.

In both embodiments of the invention, the printing mechanism 1 in the form of the extruders 3 automatically (under control of the control unit 26) prints (extrudes) the layers L of the building 3D-printing material one on the top of another (FIG. 2, 3, 6). A concrete mixture, polystyrene, foam, aerogel, polyether, polyestyrene, fibrous concrete, polypropylene fibrous concrete, nylon fibrous concrete, gypsum, gel powder and other building polymers and materials of such type which are known and understood for a skilled person may be used as the 3D-printing material. The building materials (e.g., the concrete mixture) are supplied from the containers 23 to the extruders 3 via the pipelines 24. The movable platform 25 moves the entire system of operating members into a required position relative to the object 41 to be printed. The movement manipulator 5 and the link 27 move and/or stationary hold the multi-component platform 28 with the extruders 3 and with the mechanism 2 for smoothing and treating surfaces with liquids within the 3D-printing area and treatment, smoothing of the surfaces (preferably, above the horizontal surface of the object 41 to be printed). One extruder 3 or several extruders 3, by means of the motors 35, are moved in the system of the multi-component platform 28 relative to the surface of the object 41 to be printed and apply the layers L of the building material one on top of another (FIG. 2, 3, 6). By means of the inclination motors 36, one or any of the several extruders 3 (independently of each other) may change their inclination towards different directions relative to the own vertical axis Z₁ at the angle α of between 0° and 90° during the printing. In such way, the elements of buildings and structures are printed by means of the 3D-printing method with a single building material (if one extruder 3 is provided) or with several layers and several building materials simultaneously (if several extruders 3 are provided). Furthermore, owing to: the structure of the multi-component platform 28, presence or arrangement of one or several extruders 3 with the motors 35 and with the inclination motors 36, a quick movement of complex protruding and/or recessed, and/or horizontal elements of buildings and structures (the objects 41 to be printed) with the simultaneous smoothing of their surfaces is enabled.

In both embodiments of the invention, at the same time with the 3D-printing process, the mechanism 2 for smoothing and treating surfaces with liquids performs smoothing and/or treatment of the outer surface of at least two lower layers L that have been already made by the extruder 3 or extruders 3. Therewith, the mechanism 2 for smoothing and treating surfaces with liquids has various implementation variants, each being able to provide smoothing and/or treatment (polishing) of at least one outer surface of the at least two layers L of the object 41 to be printed and being built in a single operation cycle of the system.

During operation of the first embodiment of the invention, the printing mechanism 1 prints the layers L (L₁ and L₂ in FIG. 3). At this moment, the dispenser 9, the side extruder 10, and the smoothing plate 11 are in a passive “waiting” state. In a preferable implementation case of the invention, the extruder 3 or each of the extruders 3 prints and applies the building material approximately at the right angle relative to the upper horizontal plate of the object 41 to be printed. That is, all Z₁ of the extruders 3 are arranged almost perpendicularly to the upper layer L that is printed by one or several extruders 3 (except for cases, when the extruders 3 have a certain inclination along the vertical due to the inclination motors 36). When the layers L (L₁ and L₂ in FIG. 3) have been already printed, then, along the movement direction of the extruder 3 or extruders 3 which print the next layer L₃ (FIG. 3), the side extruder 10 (moving together with the movement of the multi-component platform 28 and/or moving by means of the movable manipulator 34) applies, sidewise and along the printed layers L₁ and L₂, the additional layer [symbol] (FIG. 3) of the building material (e.g., the concrete) into a formed small pocket (recess) between these two lower already provided layers L₁ and L₂. That is, the side extruder 10 (during the process of printing the next layer L₃) simultaneously fills void slots between the already printed layers L₁ and L₂, as well as the side extruder 10 “fills” the roughnesses of the surface of the newly printed layers L with the additional layer e. Preferably, this is made with regard to the outer vertical surface of the object 41 to be printed, e.g., with regard to the wall, but without limitation thereto. Due to fixation of the side extruder 10 to the multi-component 28 and by means of the movable manipulator of the smoothing mechanism 34, the longitudinal axis P of the side extruder 10 may be arranged at the angle β (FIG. 3) of between 0° and 180° relative to the object 41 to be printed (e.g., relative to the vertical surface of the wall, but without limitation thereto). The “immobility” of the manipulator 34 of the smoothing mechanism, as well as legs, links thereof, enables to change said angle β within the range of between 0° and 180° relative to the object 41 to be printed during the 3D-printing and to smooth and to treat the surfaces of the elements of buildings and structures with liquids. The change of the angle β of the longitudinal axis P of the side extruder 10 enables to arrange the nozzle of the side extruder 10 in a maximum effective manner relative to the surface of the object 41 to be printed and, thus, to apply, in a maximum effective, quick, and economical manner, the layer [symbol] of the building material onto the outer surfaces of the layers L (L₁ and L₂ in FIG. 3) into the formed small pockets (recesses) between these two lower layers L₁ and L₂ already made in order to perform further straightening and smoothing of these surfaces of the building element. In preferable cases of operation of the first embodiment of the invention, the side extruder 10 performs printing with the same material and the extruder 3 that has performed the main printing of the object having the surface being smoothed and/or treated. Most frequently, a shape of a printing head of the side extruder 10 is made flattened in order to provide, in combination with the spatial arrangement relative to the building surface, the most compact filling of the recess between the two lower layers L₁ and L₂ of the material and in a sufficient, but not excess amount, in order to provide a straight surface.

Immediately after the layer [symbol] is applied by the side extruder 10 into the voids-slots-recesses between the already printed layers L₁ and L₂, the smoothing plate 11 (moving simultaneously with the side extruder 10) mechanically smooths and straightens the newly applied layer e of the material according to an operation principle of “a building spatula”. Most frequently, the smoothing plate 11 has a width of a working surface that is at least twice greater than the width of the layer L (FIG. 3) being printed by the extruder 3. The liquid dispenser 9, if necessary (under control by the control unit 26), sprays the liquid (e.g., water) onto the surface to be smoothed, thereby wetting the building materials of the main layers L (L₁ and L₂ in FIG. 3) and of the layer [symbol] that is added into the voids-slots-recesses, and makes the material in the smoothing area more flexible. The liquid dispenser 9 also may treat the surfaces being built with liquid not only to wet them, but also to apply any other liquid (other than water), e.g., the waterproof mixture, the paint, other.

The process of applying the layer e by the side extruder 10 into the voids-slots-recesses and smoothing thereof is repeated during the 3D-printing of each next layer L. After the extruder 3 or each of the extruders 3 has printed the layer L, the system of operating members will pass along the two upper printed layers L two times, while the dispenser 9, the side extruder 10, and the smoothing plate 11 are in the active working state, while the extruders 3 may be in the passive state and may continue printing the layers L.

The passive or active state of the movable manipulator 34 of the smoothing mechanism, the side extruder 10, and/or the spatula 11, and/or the dispenser 9, and/or the extruders 3 or each of the extruders 3, is provided under control of the control unit 26 and due to making these details with a possibility of changing their position relative to the object 41 to be printed which is clear for a skilled person.

As a result of operation of the first embodiment of the invention, the surface of the printed element (e.g., the vertical outer surface of the wall, i.e., the object 41 to be printed) along which the side extruder 10, the smoothing plate 11, and the dispenser 9 were operating is smoothed and straight.

During operation of the second embodiment of the invention, the printing mechanism 1 prints the layers L (FIG. 2, in FIG. 6, they are shown as the layers L₁ and L₂). In the second embodiment of the structure, the mechanism 2 for smoothing and treating surfaces with liquids is made in the form of the polishing element 12 with the motor 37 (FIG. 6), and the dispenser 9 (FIG. 2), while the polishing element 12 may be made, e.g., in the form of the planishing disc (but without limitation thereto). Thus, the straightening and the treatment of the outer side surface of the two lower layers L₁ and L₂ of the object 41 to be printed are performed by means of planishing. When the layers L₁ and L₂ have been already printed, then along the movement path of the extruder 3 or extruders 3 which print the next layer L₃ or two layers L₃ and La (FIG. 6), the planishing disc (the polishing element 12) also moves along the side surface of the object 41 to be printed, and, by rotating by means of the motor 37 (on the movable manipulator 34), it treats (planishes/smooths/polishes) the outer side surface of the two lower layers L₁ and L₂. already printed. The dispenser 9 (on the movable manipulator 34), along the movement path of the polishing element 12, dispenses the liquid onto the surface of the planished wall and cleans it from a concrete or another dust, or wets the treatment surface in order to enhance the treatment process (planishing, polishing, smoothing). For example, water is used as the liquid to be dispersed, but without limitation thereto. Such process being under control by the control unit 26 is automatically repeated during the 3D-printing of each next layer L. After the extruders 3 have printed the next (the uppermost) layer L, the system of operating members passes along the two printed layers L twice (in FIG. 6, they are shown as the layers L₁ and L₂), and the polishing element 12 and the liquid dispenser 9 are in the active state, while the extruders 3 (or one extruder 3) preferably are in the active state (continue to print) or in the passive “waiting” state. As a result of the operation of the structure of the second embodiment, the surface of the printed object 41 (e.g., the entire outer surface of the printed wall) along which the polishing element 12 and the dispenser 9 were operating is treated and smoothed.

In both embodiments of the invention, in order to perform the 3D-printing of any objects 41 to be printed with a single material (e.g., with the concrete mixture), the at least one extruder 3 is mounted on the multi-component platform 28. The single 3D-printing material is supplied to the one extruder 3. The extruder 3, along the movement path thereof, extrudes the building material and forms (prints) the layer L, and the extruded building material hardens rather quickly. The extruder 3 that continuously extrudes the 3D-printing material moves according to the given path (that is defined by the control unit 26), thereby forming new layers L, each of them is deposited onto the previous layer L. The mechanism 2 for smoothing and treating surfaces with liquids straightens the outer surface of the printed layers L. This results in the plurality of the 3D-printed layers L, e.g., of the concrete mixture, which are deposited one on top of another one, forms a solid wall having the smoothed side surface that represents a finished building structure.

In particular embodiments of the invention, the solid wall may be formed from various materials. In both embodiments of the invention, in order to perform the 3D-printing with several materials at the same time, from two to six extruders 3 may be mounted on the multi-component platform 28, but without limitation thereto. Such technical solution may take place, e.g., in case of printing the solid wall by two (I and II), three (I, II, and III) or another number of different materials. Therefore, the number of the extruders 3 equals to the number of types of the material. And when performing the 3D-printing of each layer of the wall, several extruders 3 may be active at the same time, or one extruder 3 may be active, and then other extruders 3 will be in the passive state. This allows to create the solid wall from the plurality of the material layers L that represents an alternate arrangement of the layers of the different types of the material, e.g., in the order of precedence being I, II, I, II, I etc. or in the order of precedence being I, II, III, II, III, II, I, II etc., or in any other order of precedence. Such solution is used, e.g., to form “a house wall composite” from different materials. In the building field, the term “the house wall composite” usually means a wall having a thermal insulator and a waterproof layer, while the thermal insulator and the waterproof layers are formed in the wall at a step of constructing this wall. The waterproof layer may be provided by including special substances (which are known and clear for a person skilled in this field of art) into the formulation of the concrete mixture or by forming an additional or a main waterproof layer by applying a special liquid from the additional or from several additional liquid dispensers 40 onto the building object. The thermal insulator is formed in the wall directly during its construction, or cells are made in the wall for further filling them with a thermal-insulating material. A single material or different materials may be used for the 3D-printing. For example, if a concrete layer of the wall having cells for the thermal insulator is built by means of the 3D-printing of two vertical walls and a sinewave-shaped wall between them (all of them represent the objects 41 to be printed), then it will be possible for the 3D-printing system to comprise, e.g., three extruders 3, wherein the first and the second extruders 3 print the outer and the inner layers of the wall, while the third extruder 3 prints the sinewave-shaped wall between them. Since all three walls (in this example) are made from the single material being the 3D-printing concrete mixture, all three extruders 3 are connected by means of the pipelines 24 to the container 23 with the concrete mixture. Or, as another implementation case of the invention, each extruder 3 may perform the printing with its own specific material, and the corresponding container 23 with the specific 3D-printing material is connected to each extruder 3 by means of the pipelines 24. In the same way, three extruders 3 may perform the printing with two, and three different materials, and, thus, they are connected to two or three containers 23. The stated example may be the same for 2, 4, 5, 6 extruders 3 as well.

In cases, when the mechanism 2 for smoothing and treating surfaces with liquids further comprises one or several additional liquid dispensers 40 (FIG. 1), the structure of both embodiments of the system of working members, by means of the main 9 and additional liquid dispensers 40, allows to use different types of liquids to treat the surfaces of elements being built (water, waterproof mixture, paints, other).

The electric heating elements 32 at the nozzles 31 of the extruders 3 (FIG. 6, 10), in each of the embodiments of the invention, evaporate the humidity from the building mixtures which come into the extruders 3 for the further 3D-printing. In cases, when the electric heating elements 32 are mounted at the outlet nozzles 31 of the extruders 3, a quick heating and a certain reduction of the humidity of the building material occurs directly “at the output” from the extruder 3, thereby allowing, at the same time, to:
firstly, make the building material more liquid (by increasing the amount of the liquid, e.g., water, in the formulation thereof) in order to enhance its transportation along the pipeline 24 from the container 23 with the material to the extruder 3;
achieve a quicker hardening of the building material immediately after its application by the extruder 3 onto the building element (when the electric heating element 32 quickly heats and evaporates the humidity from the building material “at the output” from the nozzle 31 of the extruder 3).

In case of the 3D-printing of the wall composite, an issue of providing a reinforcement of the wall composite during the process of constructing thereof in order to increase its structural rigidity becomes actual. To this end, the claimed system of operating members further comprises the reinforcing device 13 with the brackets 14 (FIG. 7-9, 11). The reinforcing device 13 operates as follows. The tray 17 with the brackets 14 is preliminary mounted in the hollow housing 15 along the wall 19 and it perpendicular to the printed layer L, and, at the same time, the tray 17 with the brackets 14 is mounted along the part A of the wall 20 and abuts against the separator 18, while the parts A and B are provided, e.g., at an angle of 140-145° one relative to another. The separator 18 (e.g., under action of pneumatic or hydraulic, or other drives) separates the bracket 14 from the tray 17, and the bracket 14 shifts downwards along the inclined part B of the wall 20 of the hollow housing 15. When the bracket 14 reaches an end of the inclined part B, the movable pusher 16 will be driven that (e.g., under action of the pneumatic or hydraulic, or other drives) starts to move along the wall 20, and gets down onto the bracket 14 with a great force, thereby leading to “escape” of the bracket 14 outwardly from the housing 15, and then, under the created mechanical force, the bracket 14, with its ends, cuts into the newly printed (not yet hardened) layers Ln of two adjacent walls. The control of operation of the separator 18 and the movable pusher 16 and their pneumatic drives may be provided by means of a separate (additional) control unit of pneumatic or hydraulic, or other drives (not shown in the drawings). The presence and the operation of the reinforcing device 13 allows to perform the process of reinforcing the building element at the same time with the 3D-printing process.

The system of operating members may be equipped with a system for cleaning from the building mixtures after the printing is completed in order to avoid hardening of the material in the flexible pipelines 24 and/or in the extruders 3, 10. In a preferable case, the cleaning system is a water cleaning system.

The stated examples of particular implementation case of each of the embodiments of the system of operating members for 3D-printing of elements of buildings and structures and for smoothing and treating their surfaces with liquids in now way limit possibilities of manufacturing various modifications of the claimed invention.

### INDUSTRIAL APPLICABILITY

The proposed system has passed tests in an experimental and industrial manufacturing and in a process of use according to a designated purpose. Results of testing the system prove that the set of essential features of each of the embodiments of the system of operating members for 3D-printing of elements of buildings and structures and for smoothing and treating their surfaces with liquids which are stated in the claims enable to achieve the claimed technical effects which lie in performing building of elements of buildings and structures with the 3D-printing method with the simultaneous process of smoothing and/or treatment of the surfaces of the elements being built in a single operation cycle of the system. That is, each of the structural embodiments of the system enables to achieve the automatic performing of the “additional treatment” of the printed elements of buildings or structures without involvement (after the 3D-printing and the additional treatment have been completed) of additional labor or mechanical resources, and, as a consequence, the operation of the system allows to reduce time, financial, and labor costs and, at the same time, to increase the quality of the printed elements of buildings and structures with the simultaneous process of smoothing and/or treatment of the surfaces of the elements being built. Furthermore, the system allows to print complex protruding and recessed elements of buildings and structures quickly. Additionally, in separate implementation cases of both embodiments of the invention, the structure of the system also allows to perform building of elements of buildings and structures by the 3D-printing method with several layers and several building materials at the same time with a simultaneous process of smoothing and/or treating the surfaces of the elements being built.

The proposed embodiments of the system of operating members for 3D-printing of elements of buildings and structures and for smoothing and treating their surfaces with liquids have passed wide tests during their experimental manufacturing, as well as in the process of the experimental use when performing the 3D-printing of elements of buildings and structures and during smoothing and treating their surfaces with liquids.

Results of the tests have shown that the structure of the proposed invention allows to create at least two embodiments of the system of operating members for 3D-printing of elements of buildings and structures and for smoothing and treating their surfaces with liquids, each of them, when using them, due to the set of all essential features, allows to achieve the described technical effects.

Examples of a particular industrial implementation of the proposed embodiments of the invention, their use, which were stated, are the best embodiments of the variants of the structures.

The proposed system of operating members for 3D-printing of elements of buildings and structures and for smoothing and treating their surfaces with liquids meets all requirements of its use, usage, and the commonly accepted safety regulations as to use of such structures for the building industry.

What is claimed is:

1. A system of working members for 3D-printing of elements of buildings and structures and for smoothing and treating their surfaces with liquids, the system comprising:
a printing mechanism (1), a mechanism (2) for smoothing and treating the surfaces with liquids that comprises
a surface smoothing device (8) and a disperser (9) for liquids, and a connection element (4) for connecting the printing mechanism (1) to a movement manipulator (5) of the system of working members for 3D-printing, smoothing and treating the surfaces, and
the connection element (4) is connected to a link (27) of the movement manipulator (5),
the printing mechanism (1) is made in a form of at least one extruder (3), and one or several such extruders (3) is/are mounted on the connection element (4) in a movable fashion relative to an object (41) to be printed, as well as one or each of the several extruders (3) is connected to a system (42) for delivering building 3D-printing materials and configured to apply a plurality of layers L of the building material deposited one on another, wherein
the connection element (4) is made in a form of a composite platform (28) that comprises a guiding element (39) for the extruder (3) or for the several extruders (3), and the composite platform (28), in its upper portion (29), is connected to the link (27) of the movement manipulator (5) such that the composite platform (28) rotates in a horizontal plane around its own axis Z2, wherein the printing mechanism (1) in the form of one or several extruders (3) and the mechanism (2) for smoothing and treating surfaces with liquids are mounted on the composite platform (28) such that they move together with the composite platform (28) relative to the object (41) to be printed, wherein the extruder (3) or each of the extruders (3) comprises a motor (35) for an independent horizontal movement of each of the extruders (3) along a guiding element (39) along a horizontal axis X of the composite platform (28), as well as the extruder (3) or each of the extruders (3) comprises a motor (36) for an inclination relative to its own vertical axis Z₁ at an angle a of between 0° and 90°, and the extruder (3) or each of the extruders (3) with the motors (35), (36) is mounted in the composite platform (28) such that it/they move horizontally towards different directions along the composite platform (28) due to the guiding element (39), as well as such that each of the extruders (3) inclines towards different directions relative to its own vertical axis Z₁ at an angle α of between 0° and 90°, furthermore, the mechanism (2) for smoothing and treating surfaces with liquids further comprises a side extruder (10), wherein the surface smoothing device (8) is made in a form of a smoothing plate (11), and all the elements of the mechanism (2) for smoothing and treating surfaces with liquids: the side extruder (10), the smoothing plate (11), and the liquid dispenser (9) are mounted and fixed to the composite platform (28) by means of a movable manipulator (34) of the smoothing mechanism that is freely movable such that a longitudinal axis P of the side extruder (10) is arranged at an angle β of between 0° and 180° relative to a surface of the object (41) to be printed and this angle β is changeable in a course of operation of the system of the working members, wherein the side extruder (10) is connected to the system (42) for delivering building 3D-printing materials and is configured to apply additional layers I of the 3D-printing material onto surfaces of at least two layers L previously printed by the extruder (3) or several extruders (3), furthermore, the smoothing plate (11) is arranged such that it is capable of smoothing the additional layers I of the 3D-printing material in a course of the movement and printing of the side extruder (10).

2. A system of working members for 3D-printing of elements of buildings and structures and for smoothing and treating their surfaces with liquids, the system comprising a printing mechanism (1), a mechanism (2) for smoothing and treating surfaces with liquids that comprises a surface smoothing device (8) and a disperser (9) for liquids, and a connection element (4) for connecting the printing mechanism (1) to a movement manipulator (5) of the system of working members for 3D-printing, smoothing and treating the surfaces, and the connection element (4) is connected to a link (27) of the movement manipulator (5), the printing mechanism (1) is made in a form of at least one extruder (3), and one or several such extruders (3) is/are mounted on the connection element (4) in a movable fashion relative to an object (41) to be printed, as well as one or each of the several extruders (3) is connected to a system (42) for delivering building 3D-printing materials and configured to apply a plurality of layers L of the building material deposited one on another, wherein the connection element (4) is made in a form of a composite platform (28) that comprises a guiding element (39) for the extruder (3) or for the several extruders (3), and the composite platform (28), in its upper portion (29), is connected to the link (27) of the movement manipulator (5) such that the composite platform (28) is capable of rotating in a horizontal plane around its own axis Z₂, wherein the printing mechanism (1) in a form of one or several extruders (3) and the mechanism (2) for smoothing and treating surfaces with liquids are mounted on the composite platform (28) such that they are moving together with the composite platform (28) relative to the object (41) to be printed, wherein the extruder (3) or each of the extruders (3) comprises a motor (35) for an independent horizontal movement of each of the extruders (3) along the guiding element (39) along a horizontal axis X of the composite platform (28), as well as the extruder (3) or each of the extruders (3) comprises a motor (36) for an inclination relative to its own vertical axis Z₁
at an angle α of between 0° and 90°, and the extruder (3) or each of the extruders (3) with the motors (35), (36) is mounted in the composite platform (28) such that it is moving horizontally towards different directions along the composite platform (28) due to the guiding element (39), as well as such that it is inclining each of the extruders (3) towards different directions relative to its own vertical axis Z₁ at an angle α of between 0° and 90°, furthermore, the mechanism (2) for smoothing and treating surfaces with liquids is made in a form of a polishing element (12) with a motor (37), and all the elements of the mechanism (2) for smoothing and treating surfaces with liquids: the polishing element (12) and the liquid dispenser (9) are mounted and fixed to the composite platform (28) by means of a movable manipulator (34) of the smoothing mechanism that is freely movable in different planes such that the polishing element (12) and its working surface (38) are arranged such that an inclination angle γ of the polishing element (12) and its working surface (38) is changeable relative to a surface of the object (41) to be printed during operation of the system of the working members.

3. The system of working members for 3D-printing of elements of buildings and structures and for smoothing and treating their surfaces with liquids according to claim 1 or according to claim 2, wherein the printing mechanism (1) comprises from two to six extruders (3) with from two to six pipelines (24) respectively connected thereto, and the extruders (3) are mounted on the composite platform (28) such that they are capable of applying the plurality of the layers L of one building material deposited one on another or several different building 3D-printing materials simultaneously.

4. The system of working members for 3D-printing of elements of buildings and structures and for smoothing and treating their surfaces with liquids according to any one of claims 1-3, wherein the composite platform (28) is made in a form of a horizontally arranged U-shaped profile, wherein an upper portion (29) of the composite platform (28) is closed, and a lower portion (30) of the composite platform (28) is opened, wherein planes of the U-shaped profile form an inner cavity (33) of the composite platform (28) with the guiding element in a form of a horizontal guiding bar (39) mounted therein for one horizontal movement motor (35) of one extruder (3) or for the horizontal movement motors (35) of the extruders (3).

5. The system of working members for 3D-printing of elements of buildings and structures and for smoothing and treating their surfaces with liquids according to any one of claims 1-3, wherein the composite platform (28) is made in a form of a horizontally arranged II-shaped profile, wherein an upper portion (29) and a lower portion (30) of the composite platform (28) are opened, and planes of the II-shaped profile form an inner cavity (33) of the composite platform (28) with the guiding element in a form of a horizontal guiding bar (39) mounted therein for one horizontal movement motor (35) of one extruder (3) or for the horizontal movement motors (35) of the extruders (3).

6. The system of working members for 3D-printing of elements of buildings and structures and for smoothing and treating their surfaces with liquids according to any one of claims 1-5, wherein the mechanism (2) for smoothing and treating surfaces with liquids further comprises one or several additional liquid dispensers (40), each being configured to dispense identical or different liquids, and each being fixed to the composite platform (28) by means of the movable manipulator (34) of the smoothing mechanism that is freely movable in different planes.

7. The system of working members for 3D-printing of elements of buildings and structures and for smoothing and treating their surfaces with liquids according to any one of claims 1-6, further comprises a device (13) for reinforcing the object (41) to be printed.

8. The system of working members for 3D-printing of elements of buildings and structures and for smoothing and treating their surfaces with liquids according to claim 7, wherein the reinforcing device (13) is made in a form of a hollow housing (15) having a tapered lower portion and formed by walls (19, 20, 21, 22), wherein the wall (19) is made straight, while the wall (20) is formed by parts A, B, C, wherein the parts A and C are arranged vertically and connected between each other by the part B that is arranged in an inclined fashion at an angle relative to the walls A and C, while the parts A and B are arranged at an angle of 90°-170° to each other, wherein a movable pusher (16), a tray (17) with brackets (14), and a divider (18) are mounted within the hollow housing (15), and the movable pusher (16) is vertically movable along the wall (19), furthermore, the tray (17) is mounted along the part A of the wall (20) and abuts against the divider (18).

9. The system of working members for 3D-printing of elements of buildings and structures and for smoothing and treating their surfaces with liquids according to any one of claims 1-8, wherein an electric heating element (32) is mounted at an outlet nozzle (31) of one extruder (3) or at each of outlet nozzles (31) of each of the several extruders (3), the electric heating element has the same shape as the shape of the inner walls of the outlet nozzle (31) of the corresponding extruder (3).
